(19) United States
(12) Patent Application Publication
(10) Pub. No.: US 2008/0070198 A1
(43) Pub. Date: Mar. 20, 2008

(54) Computerized method, system and machine-readable medium to enable a user to remotely perform a decorating session on an electronic image

(75) Inventor: Daniel J. Dempsey, Northville, MI (US)

Correspondence Address: BROOKS KUSHMAN P.C., 1000 TOWN CENTER, TWENTY-SECOND FLOOR, SOUTHFIELD, MI, 48075, US

(73) Assignee: Chameleon Technologies Corporation, Northville, MI (US)

(21) Appl. No.: 11/505,580

(22) Filed: Aug. 17, 2006

(51) Int. Cl. G09B 25/00

(52) U.S. Cl. 434/72

(57) ABSTRACT

A computerized method, system and machine-readable medium to enable a user to remotely perform a decorating session on an electronic image are provided. The method includes: receiving, at a client computer, a user-supplied digital image having an area to be decorated; interactively mapping, at the client computer, the area to be decorated with a product to obtain a mapped image; transmitting the mapped image to a web server over a public communications network; and providing either the user or another user access to a user-selected web site supported by the web server over the public communications network to enable the user or other user to perform a decorating session. During the session, the user or other user electronically applies product images to the area to be decorated and views the results of the session prior to generating an order for the product.

### BACKGROUND OF THE INVENTION

1. Field of the Invention

This invention relates to computerized methods, systems and machine-readable media which enable a user to remotely perform a decorating session on an electronic image.

2. Background Art

Homeowners, designers, decorators, etc. have been able to alter or render an electronic image offline in order to make product and decoration decisions. However, it is desirable to alter or render such images online or on a website, thereby using the web to make product and decoration decisions.

The U.S. patent application publication to Magee, et al. 2003/0139840 A1 provides for an Interactive System and Method for Design, Customization and Manufacture of Decorative Textile Substrates. Disclosed in an Internet/web-based system 10 and interactive method for allowing a user, from a remote location, to generate a custom design by providing the user with access to web-based image manipulation design tools over a public communications network wherein the user may upload a scanned image to a website server 20, and, in conjunction with the image manipulation design tools, change colors, crop the image, eliminate or edit the background or backdrop and otherwise create a customized product utilizing the user-uploaded image.

The U.S. patent application publication to Elgar, et al. 2004/0160624 A1 provides for an Apparatus and Method for Manipulating Images. Disclosed is a web-based method for manipulating images online by utilizing a browser-based image manipulation software 254, wherein a customer may perform image manipulations 112 (e.g., resizing, overlaying, rotating, placing) on customer-uploaded images stored at a web server.

The U.S. patent application publication to Look, et al. 2004/0225968 A1 provides for a Method and Apparatus for Providing Access to and Working with Architectural Drawings on the Internet. Disclosed is an Internet-based design environment implemented on a web server for use by building, design, architectural, engineering and construction personnel wherein virtual work space area 300 and toolbar 302 provide a virtual desktop for allowing a designer to create, edit, view and manipulate design documents, including sketches, hard-line drawings, models, images, schedules and specifications (see assignee related U.S. patent application publication 2002/0049786 A1 for relevant art disclosure).

The U.S. patent application publication to Nykamp 2005/0251462 A1 provides for Systems and Methods for Interactively Displaying Product Information and for Collaborative Product Design. Disclosed is a web-based interactive product (e.g., floor plans, planograms) design system and method wherein multiple users may independently manipulate an uploaded digital picture of a product in a distributed collaborative environment.

The U.S. patent application publication to Schuller, et al. 2001/0047250 A1 provides for an Interactive Decorating System. Disclosed is an Internet-based, web site method for enabling users to interactively decorate spaces, like rooms in a house.

The U.S. patent application publication to MacInnes, et al. 2005/0081161 A1 provides for a Three-Dimensional Interior Design System. Disclosed is a client-server computing environment for generating and rendering a photorealistic three-dimensional (3D) perspective view of a 3D object selectively positioned within a 3D scene.

The U.S. patent application publication to Bibliowicz 2002/0049786 A1 provides for a CAD collaboration tool.

Other references related to the present invention include the following: US 2002/0093538 and U.S. Pat. No. 5,255,352.

### SUMMARY OF THE INVENTION

An object of the present invention is to provide a computerized method, system and machine-readable medium to enable a user to remotely perform a decorating session on an electronic image wherein a user-supplied digital image having an area to be decorated is interactively mapped with a product to obtain a mapped image. In this way, the mapped image is dynamic so it can be altered or decorated online at a web site via a public communication network such as the Internet.

In carrying out the above object and other objects of the present invention, a computerized method is provided to enable a user to remotely perform a decorating session on an electronic image. The method includes: receiving, at a client computer, a user-supplied digital image having an area to be decorated; interactively mapping, at the client computer, the area to be decorated with a product to obtain a mapped image; transmitting the mapped image to a web server over a public communications network; and providing either the user or another user access to a user-selected web site supported by the web server over the public communications network to enable the user or other user to perform a decorating session. During the session, the user or other user electronically applies product images to the area to be decorated and views the results of the session prior to generating an order for the product.

The step of mapping may include the step of receiving a first set of user-generated signals to select a surface of the area to be decorated with the product.

The step of mapping may include the step of receiving a second set of user-generated signals to outline a region of the surface to be decorated.

The step of mapping may include the step of receiving a third set of user-generated signals to outline a perspective area of the region, the perspective area controlling angle and shape of the product to be applied to the region.

The step of mapping may include the step of receiving a fourth set of user-generated signals to rotate the perspective area.

The step of mapping may include the step of receiving a fifth set of user-generated signals to obtain dimensions of the perspective area.

The user-supplied digital image may be a photographic image.

The area may be an exterior surface of a building and the product may be an exterior product.

The area may be an interior surface of a building and the product may be an interior product.

Further in carrying out the above object and other objects of the present invention, a system is provided to enable a user to remotely perform a decorating session on an electronic image. The system includes means for receiving a user-supplied digital image having an area to be decorated, and a client computer configured to: interactively map the area to be decorated with a product to obtain a mapped image; transmit the mapped image to a web server over a public communications network; and provide either the user or another user access to a user-selected web site supported by the web server over the public communications network to enable the user or other user to perform a decorating session. During the session, the user or other user electronically applies product images to the area to be decorated and views the results of the session prior to generating an order for the product.

The client computer may be configured to receive a first set of user-generated signals to select a surface of the area to be decorated with the product.

The client computer may be configured to receive a second set of user-generated signals to outline a region of the surface to be decorated.

The client computer may be configured to receive a third set of user-generated signals to outline a perspective area of the region, the perspective area controlling angle and shape of the product to be applied to the region.

The client computer may be configured to receive a fourth set of user-generated signals to rotate the perspective area.

The client computer may be configured to receive a fifth set of user-generated signals to obtain dimensions of the perspective area.

The user-supplied digital image may be a photographic image.

The area may be an exterior surface of a building and the product may be an exterior product.

The area may be an interior surface of a building and the product may be an interior product.

Still further in carrying out the above object and other objects of the present invention, a machine-readable medium is provided having encoded thereon program code, wherein, when the program code is execute on a machine, the machine implements a method to enable a user to remotely perform a decorating session on an electronic image. The method includes the steps of: receiving a user-supplied digital image having an area to be decorated; interactively mapping the area to be decorated with a product to obtain a mapped image; transmitting the mapped image to a web server over a public communications network; and providing either the user or another user access to a user-selected web site supported by the web server over the public communications network to enable the user or other user to perform a decorating session. During the session, the user or other user electronically applies product images to the area to be decorated and views the results of the session prior to generating an order for the product.

The step of mapping may include the step of receiving a first set of user-generated signals to select a surface of the area to be decorated with the product.

The step of mapping may include the step of receiving a second set of user-generated signals to outline a region of the surface to be decorated.

The step of mapping may include the step of receiving a third set of user-generated signals to outline a perspective area of the region, the perspective area controlling angle and shape of the product to be applied to the region.

The step of mapping may include the step of receiving a fourth set of user-generated signals to rotate the perspective area.

The step of mapping may include the step of receiving a fifth set of user-generated signals to obtain dimensions of the perspective area.

The user-supplied digital image may be a photographic image.

The area may be an exterior surface of a building and the product may be an exterior product.

The area may be an interior surface of a building and the product may be an interior product.

The above object and other objects, features, and advantages of the present invention are readily apparent from the following detailed description of the best mode for carrying out the invention when taken in connection with the accompanying drawings.

### BRIEF DESCRIPTION OF THE DRAWINGS

FIG. 1 is a schematic diagram which illustrates the various elements of a system which allows a user to remotely perform a decorating session on an electronic image;

FIG. 2 is a generalized schematic block diagram flow chart illustrating the various steps taken by the system of FIG. 1 to remotely perform the decorating session;

FIG. 3 is a schematic block diagram flow chart which illustrates many of the steps of FIG. 2 in greater detail, as well as other steps; and

FIGS. 4 through 43 are screen shots taken from the client computer of FIG. 1 and which collectively illustrate one embodiment of the invention.

### DETAILED DESCRIPTION OF THE PREFERRED EMBODIMENT(S)

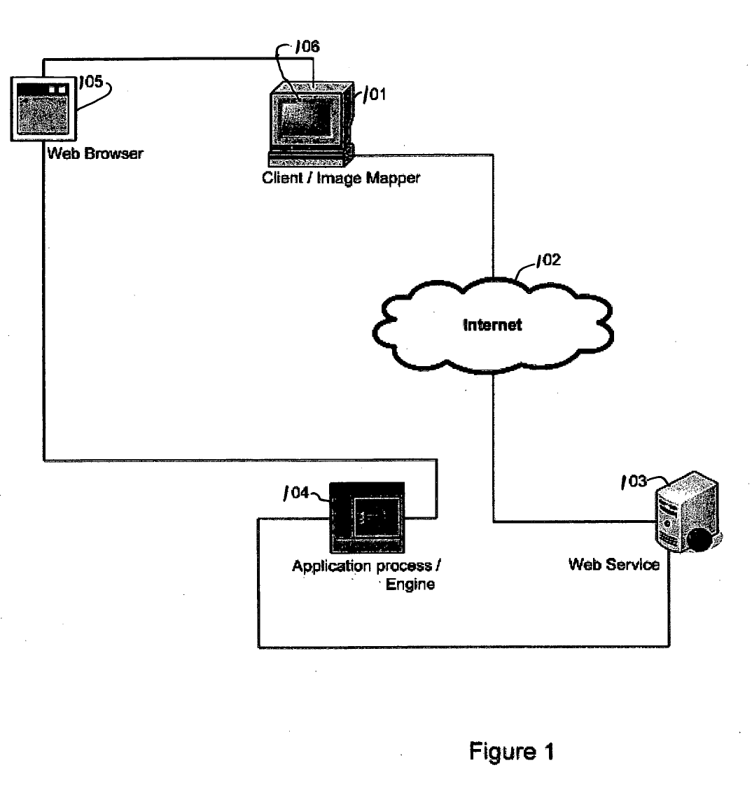

Referring now to the drawing figures, there is illustrated in FIG. 1 a schematic diagram which illustrates the various elements of a system which allows a user to remotely perform a decorating session on an electronic image.

In one embodiment of the present invention, software for implementing the present invention is referred to as “Image Mapper.” At a client/Image Mapper 101 is a client computer programmed with Image Mapper software wherein, in general, the software maps points on a user-supplied image as described in greater detail hereinbelow.

The environment of use of at least one embodiment of the present invention is the Internet 102 wherein the user completes all required criteria for a mapped image. For example, the mapped image is sent via the Internet 102 to a web service 103 which receives a user-supplied digital image, along with all of the mapping data which is generated at the client/Image Mapper 101, as described in detail hereinbelow.

At the web service 103, the image and mapping data are processed so that an application process/rendering engine 104 can interpret the image and mapping data.

A web browser 105 is opened by the Image Mapper application 101 which directs the web browser 105 to the mapped image.

A display 106 of the client computer 101 shows the end user or client where the final image is displayed on the Internet 102 and where the end user can change the surfaces on the mapped image.

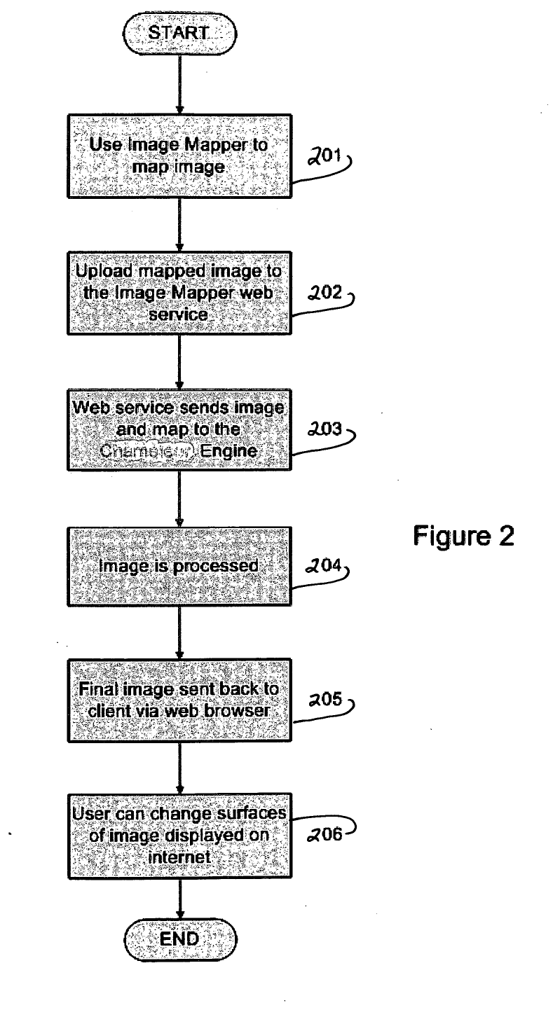

Referring now to FIG. 2, there is illustrated a generalized schematic block diagram flow chart illustrating the various steps taken by the system of FIG. 1 to remotely perform a decorating session.

At block 201, the Image Mapper 101 maps a user-supplied digital image to obtain a mapped image.

At block 202, the mapped image at the client computer 101 is uploaded to the Image Mapper web service 103.

At block 203, the web service 103 sends or transmits the user-supplied digital image and the mapping data or map to the application process/rendering engine 104.

At block 204, the image is processed by the application process/rendering engine 104.

At block 205, the file image is sent back to the client computer 101 via the web browser 105 over the Internet 102.

At block 206, the user can change surfaces of the image displayed at 106 over the Internet 102.

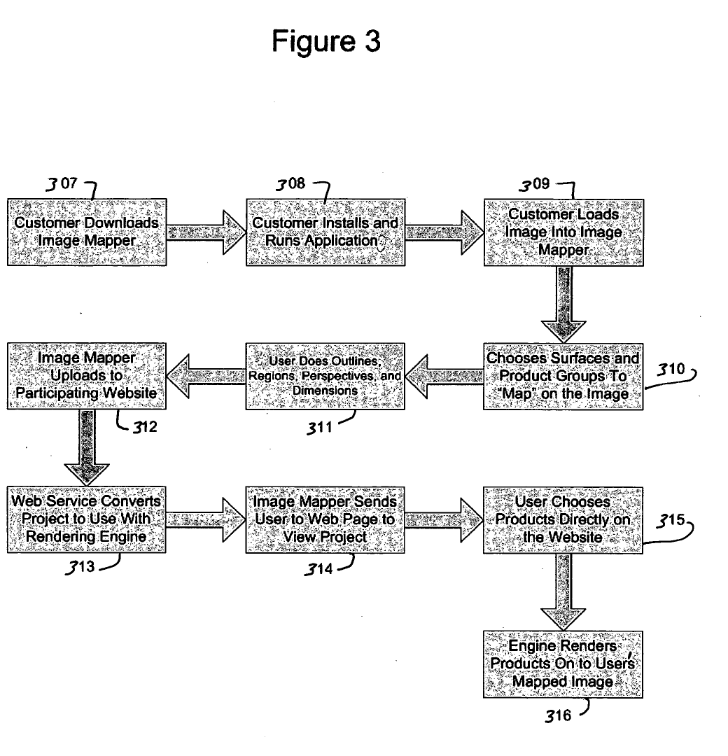

Referring now to FIG. 3 there is illustrated a schematic block diagram flow chart will illustrates many of the steps of FIG. 2 in greater detail, as well as additional steps.

At block 307, initially the customer or user downloads Image Mapper onto the client computer 101 over the Internet 102 from a web site connected to the Internet 102.

At block 308, the customer installs and runs the Image Mapper application at the client computer 101.

At block 309, the customer loads the user-supplied digital image into the Image Mapper at the client computer 101.

At block 310, the user chooses surfaces and product groups to map on the user-supplied digital image utilizing the client computer 101 programmed with the Image Mapper.

At block 311, the user does outlines, regions, perspectives and dimensions in an interactive fashion to map the area to be decorated with the product to obtain a mapped image.

At block 312, the Image Mapper uploads the mapped image to a desired participating web site over the Internet 102, as indicated by the web service 103.

The web service 103 converts the mapped image, including the mapping data to use with the application process/rendering engine 104 which may use the Chameleon engine of the assignee of the present invention.

At block 314, the Image Mapper sends the user to the web page of the web site supported by the web server through the Internet 102 to view the project or decorating session.

At block 315, the user chooses products directly on the web site supported by the web server over the Internet 102.

Finally, at block 316, the application process/rendering engine 104 renders products on the user's mapped image.

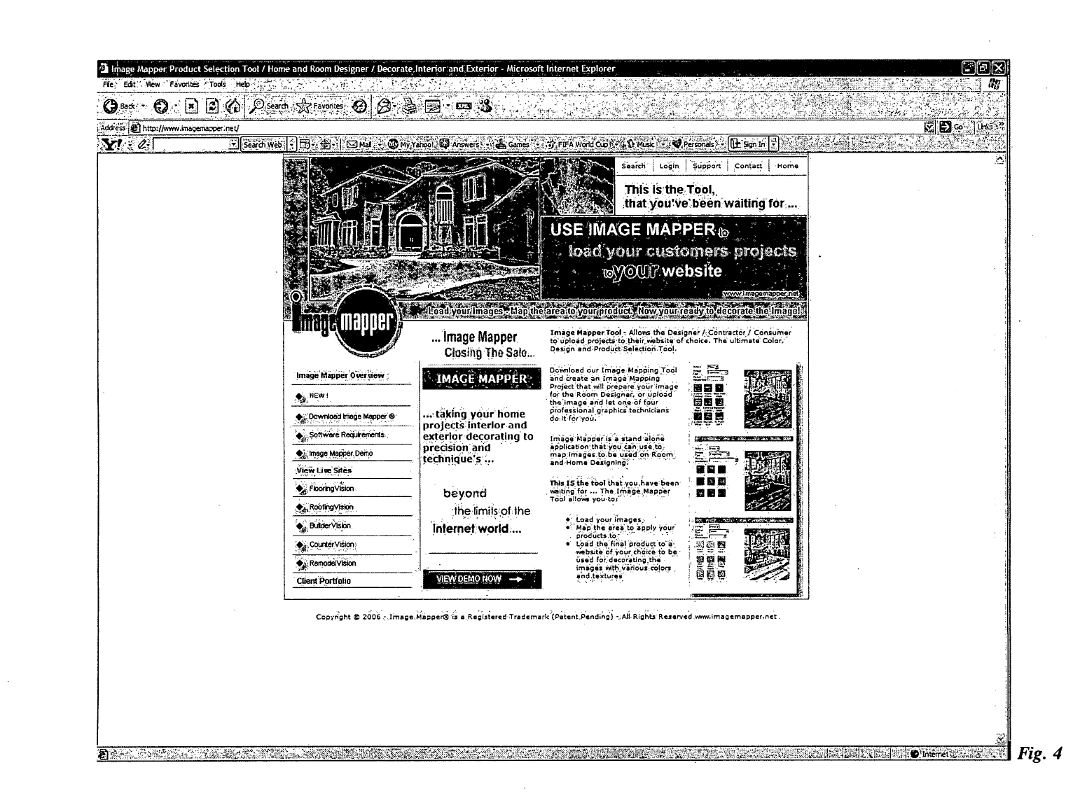

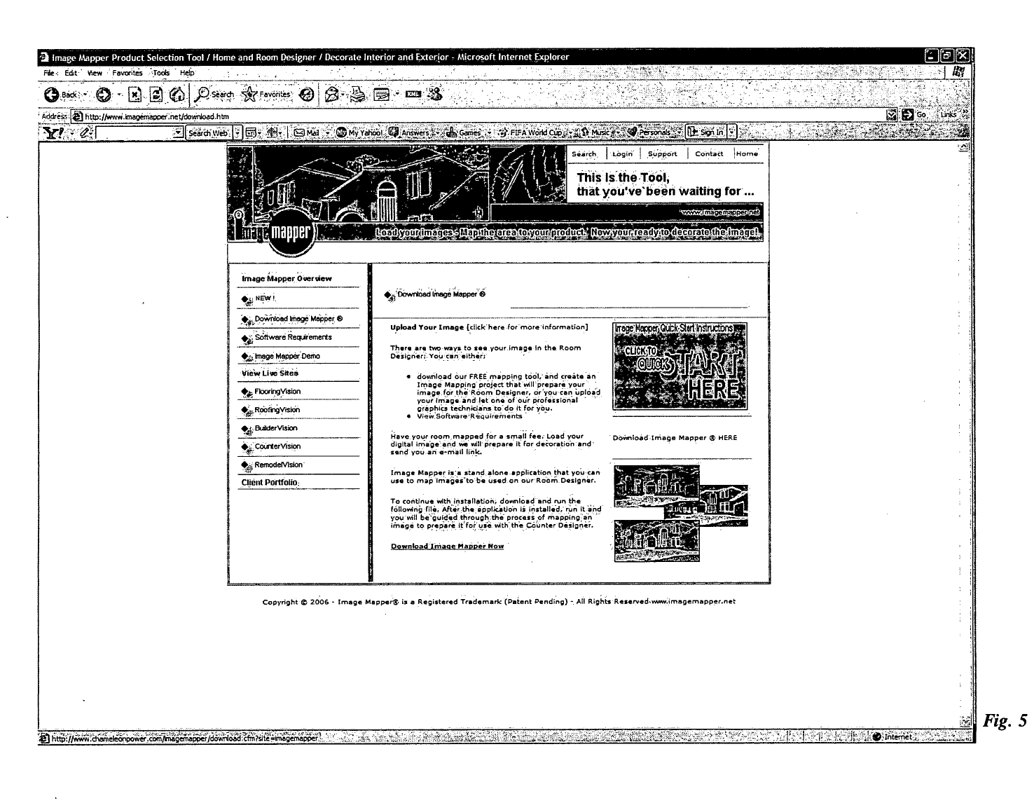

Referring now to FIGS. 4 and 5, there is illustrated screen shots taken from the client computer 101, which together comprise two pages of a web site which describes the Image Mapper tool and which allows one to download the Image Mapper to the client computer 101.

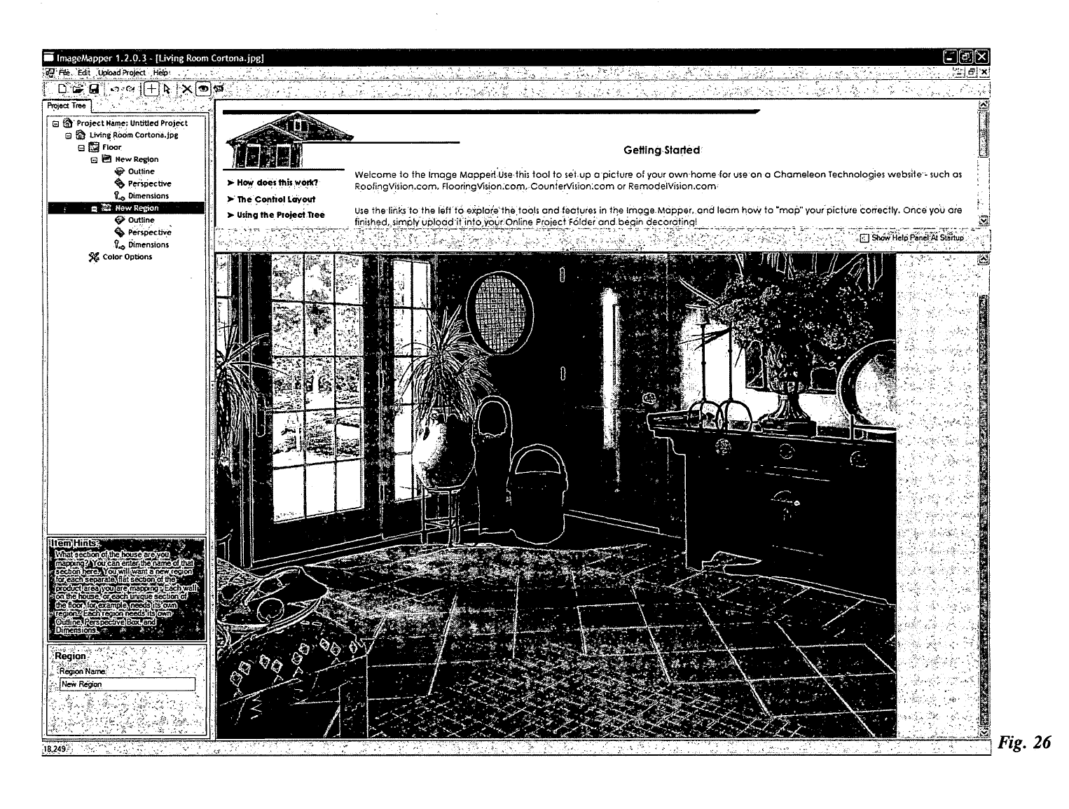

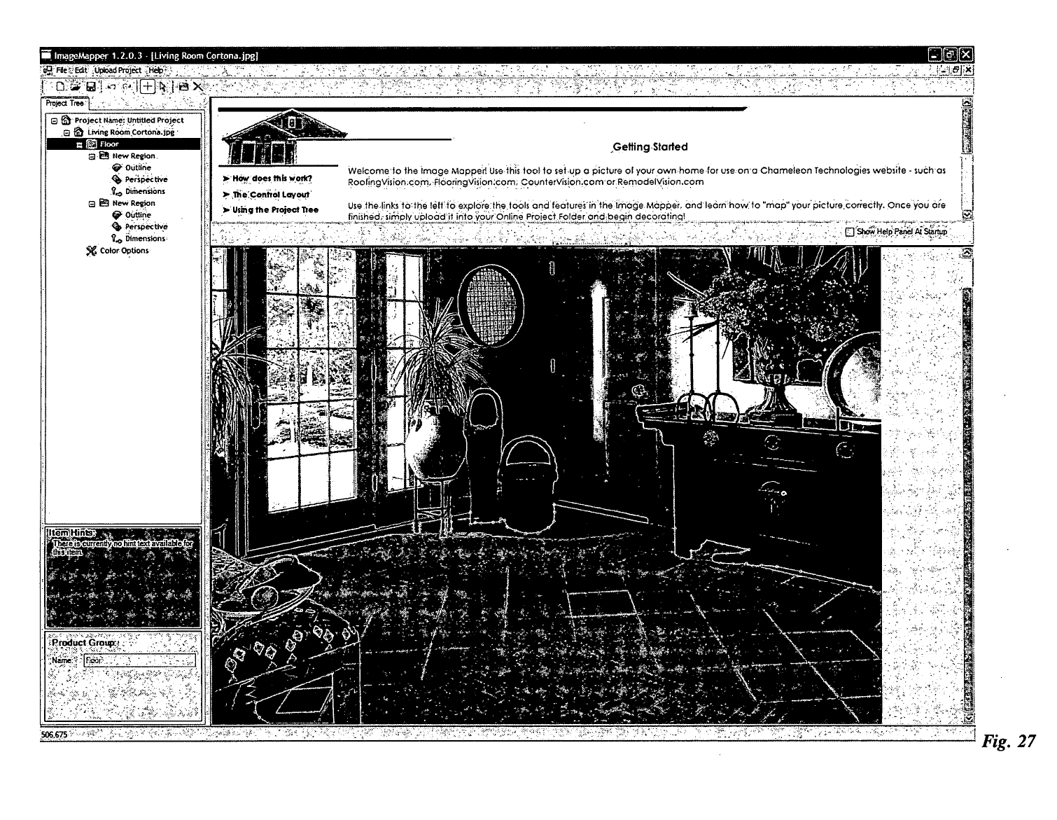

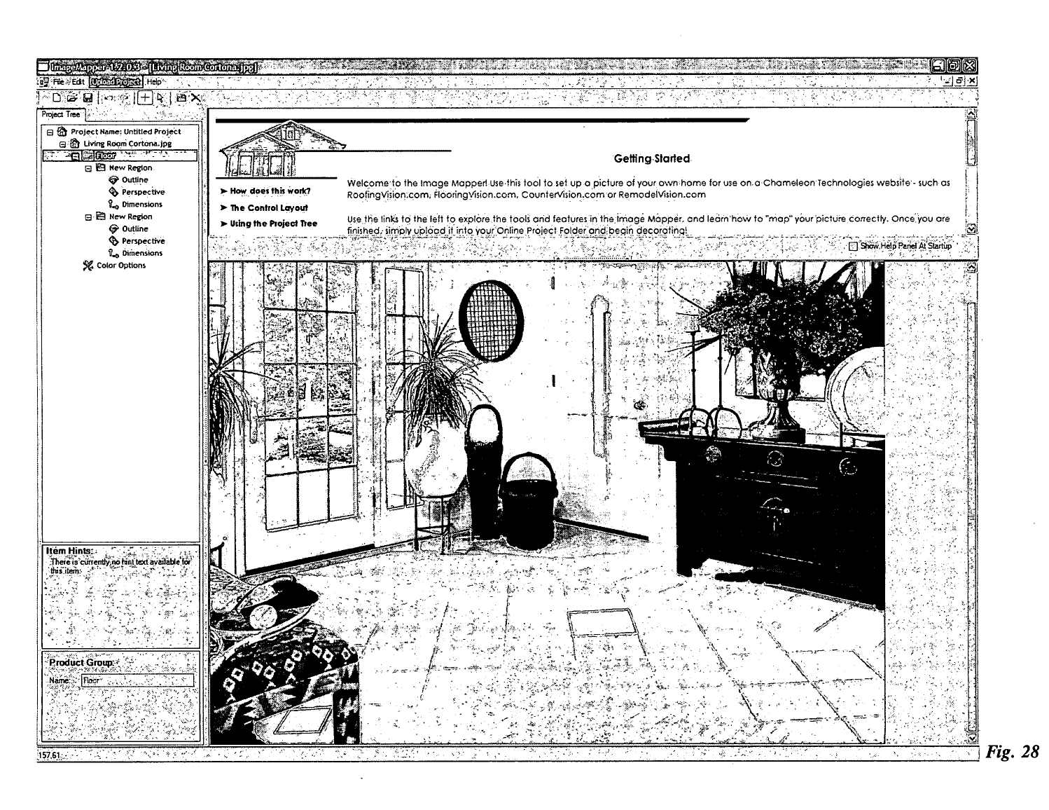

FIGS. 3 through 43 are also screen shots taken from the client computer 101 and which collectively illustrate one embodiment of the invention (i.e., the Image Mapper software installed on the client computer 101).

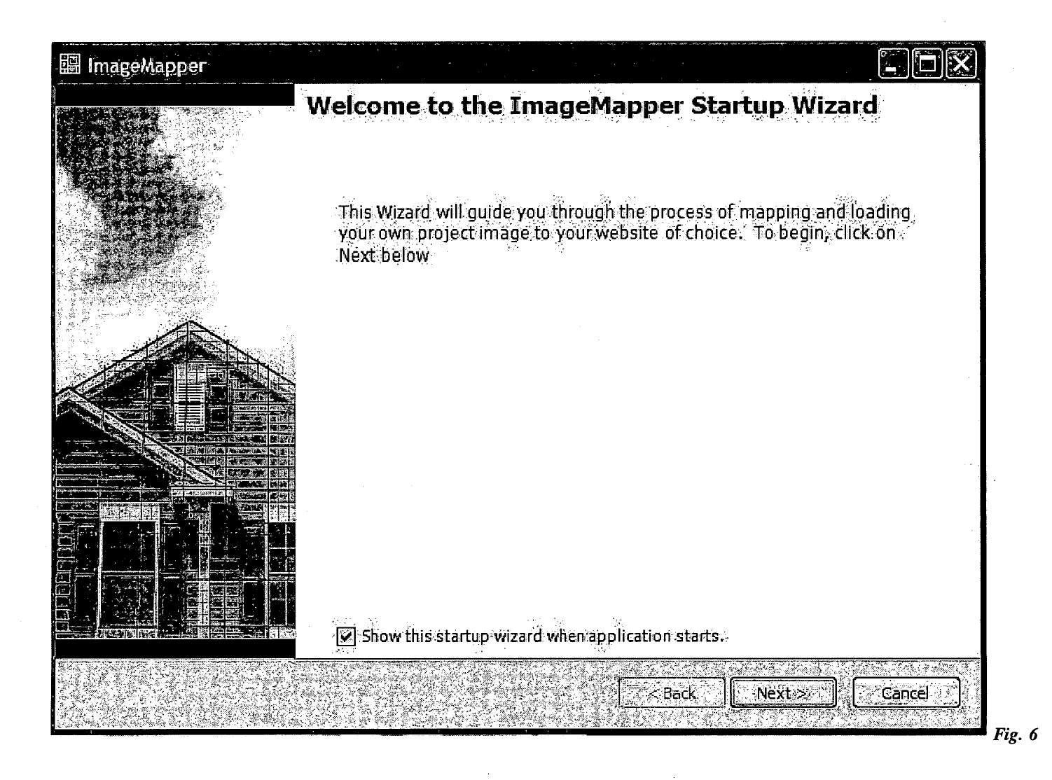

In particular, the screen shot of FIG. 6 is a screen shot which welcomes the user to the Image Mapper startup wizard.

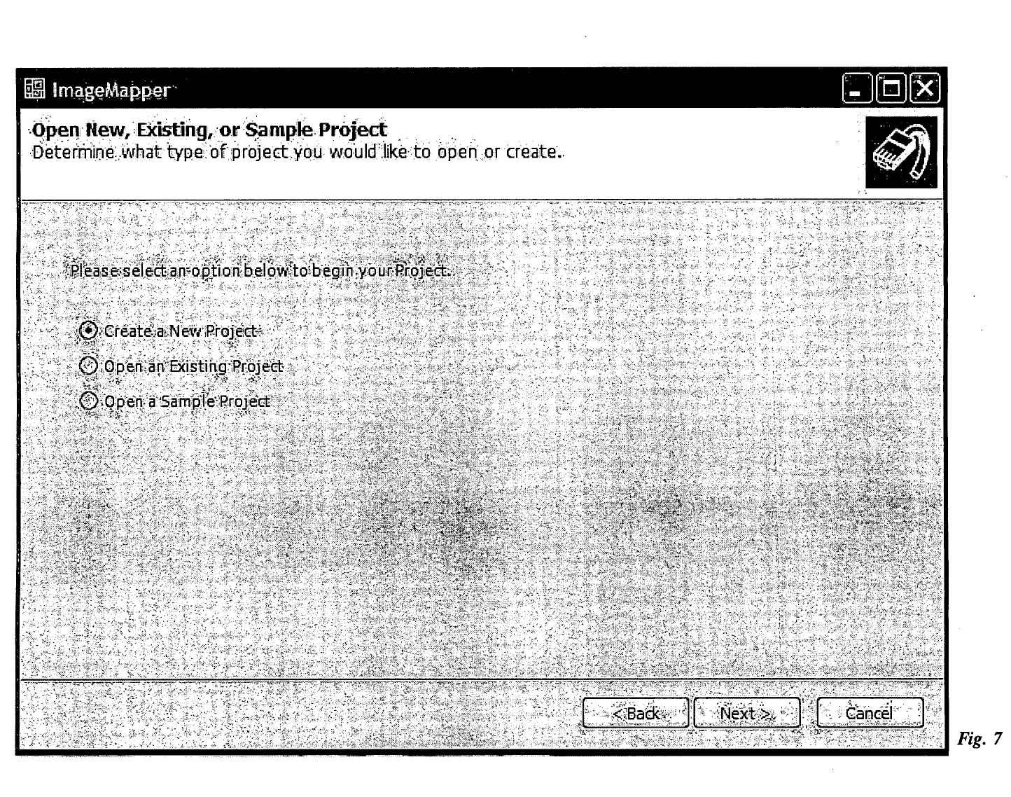

The screen shot of FIG. 7 allows a user to either create a new project, open an existing project or open a sample project.

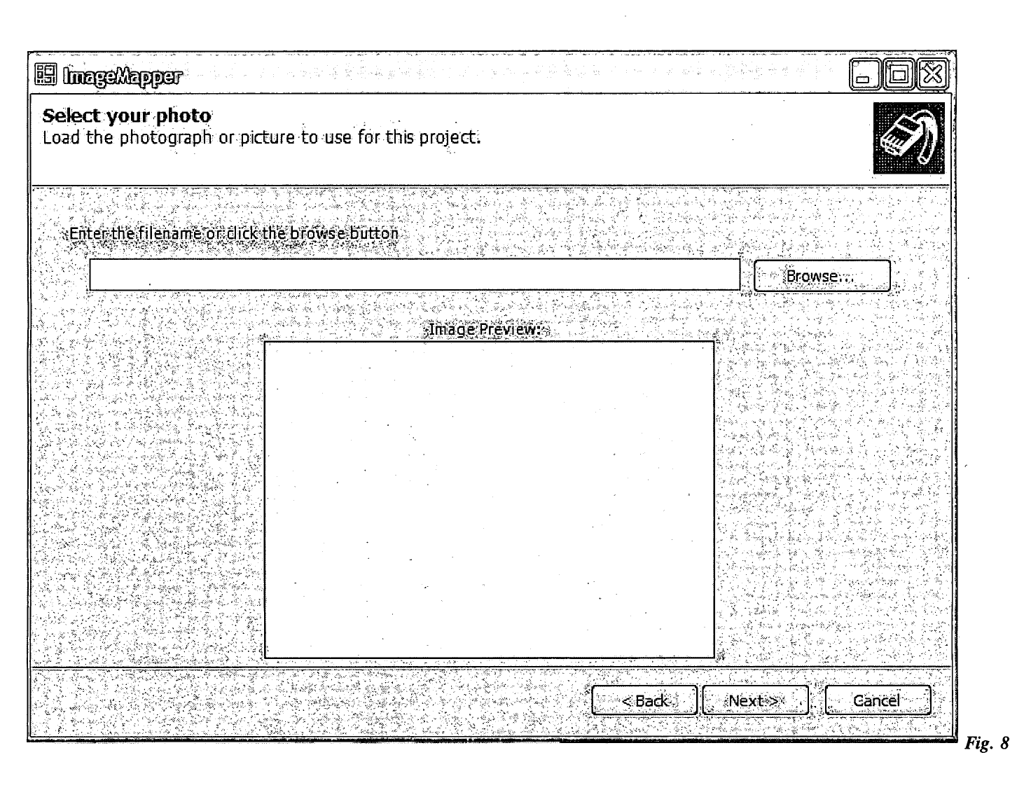

The screen shot of FIG. 8 allows an end user to select an image file loaded locally.

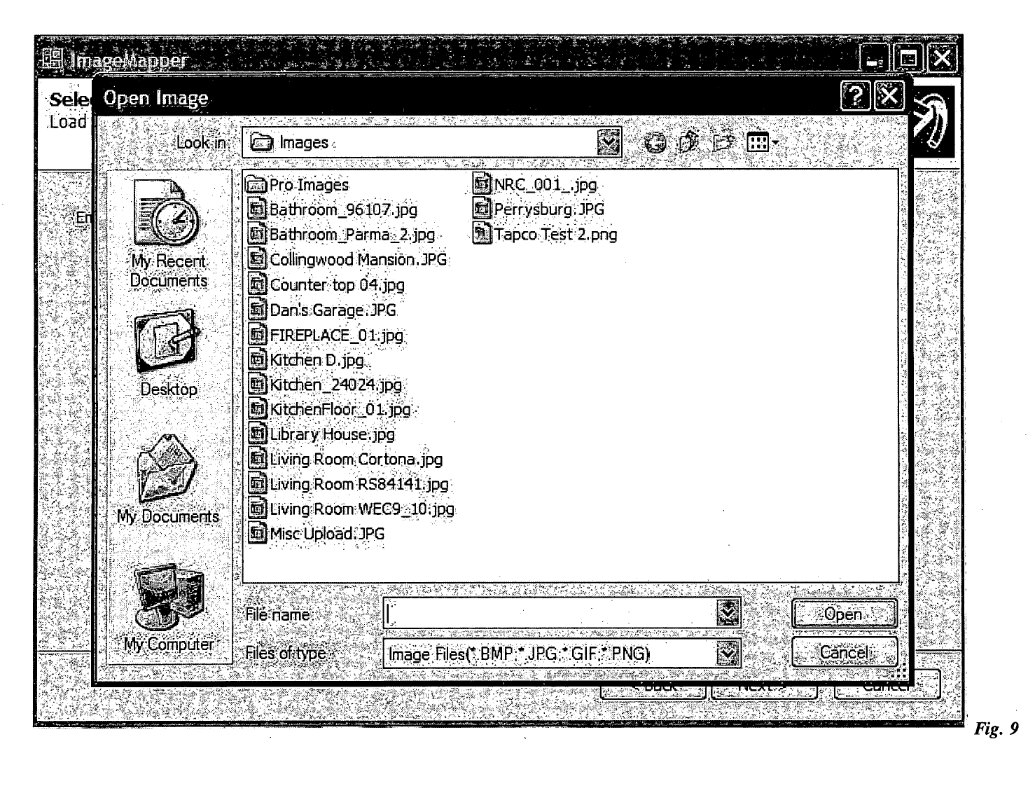

The screen shot of FIG. 9 illustrates the selection of a particular image file which may comprise a user-supplied digital image, including an interior surface or an exterior surface of a building, such as a home.

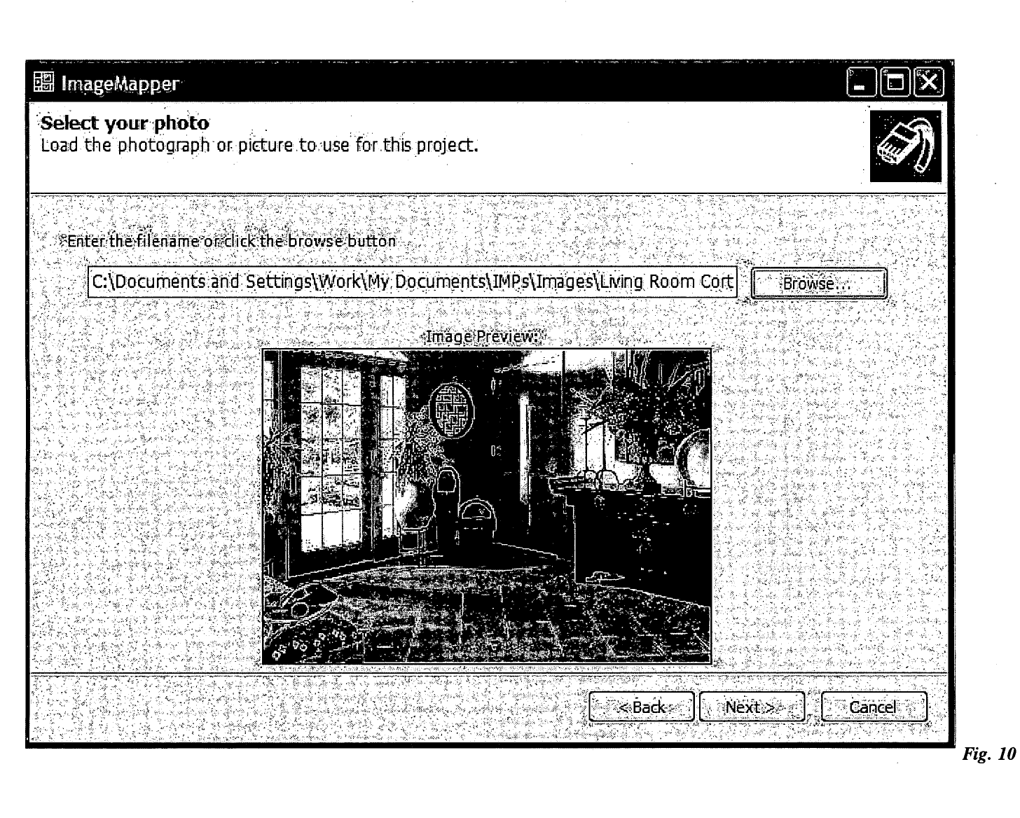

After the image selection illustrated in the screen shot of FIG. 9, a preview of the image is shown to the user as illustrated in the screen shot of FIG. 10.

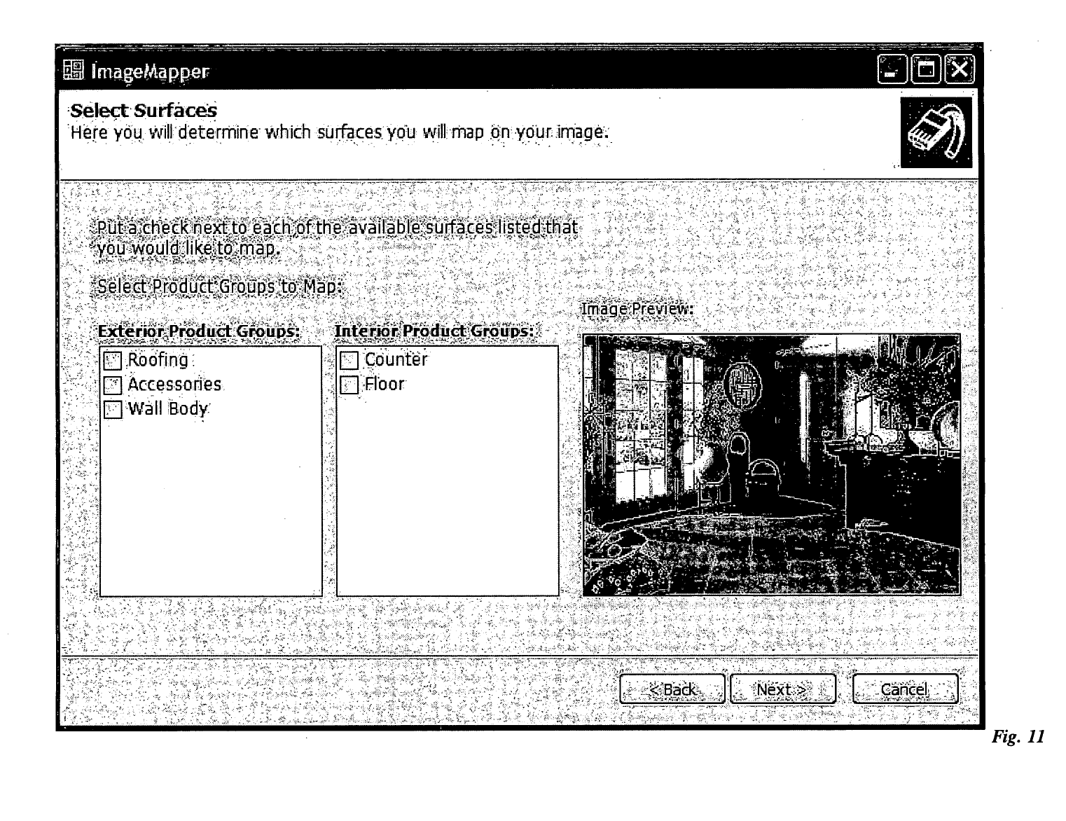

The screen shot of FIG. 11 is a screen shot which allows the end user to select a particular interior or exterior surface to be decorated with an interior or exterior product, respectively, of a product group.

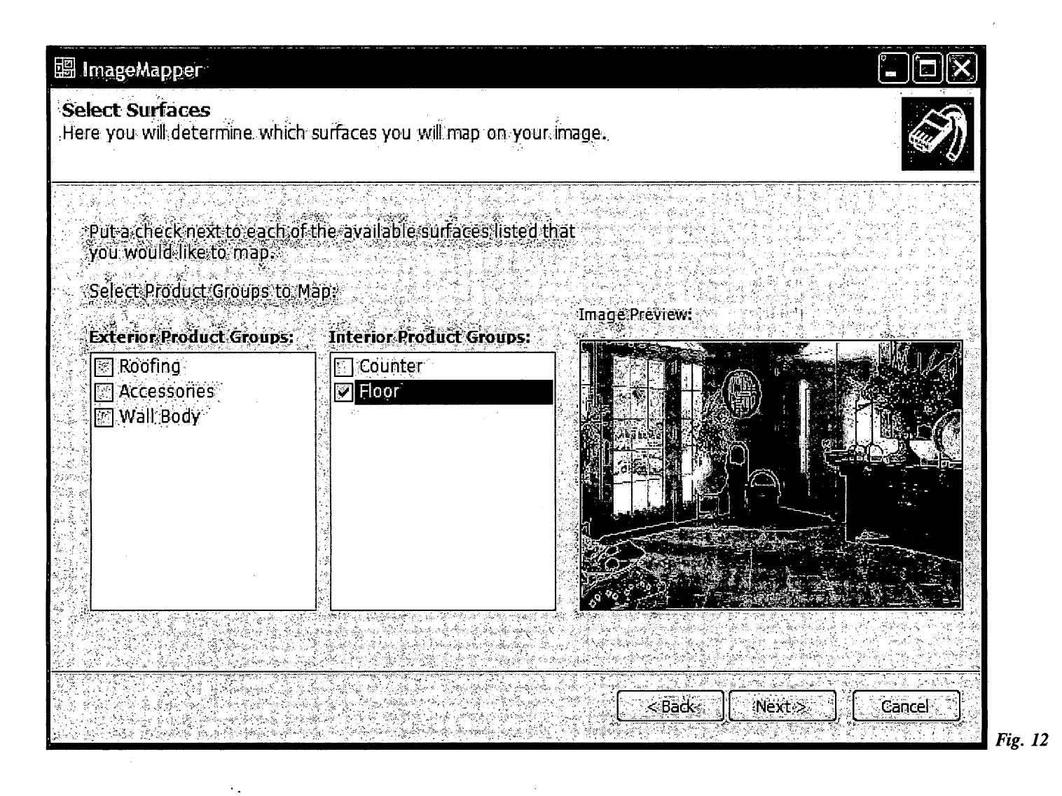

The screen shot of FIG. 12 shows the selection by the user of a floor surface to be decorated.

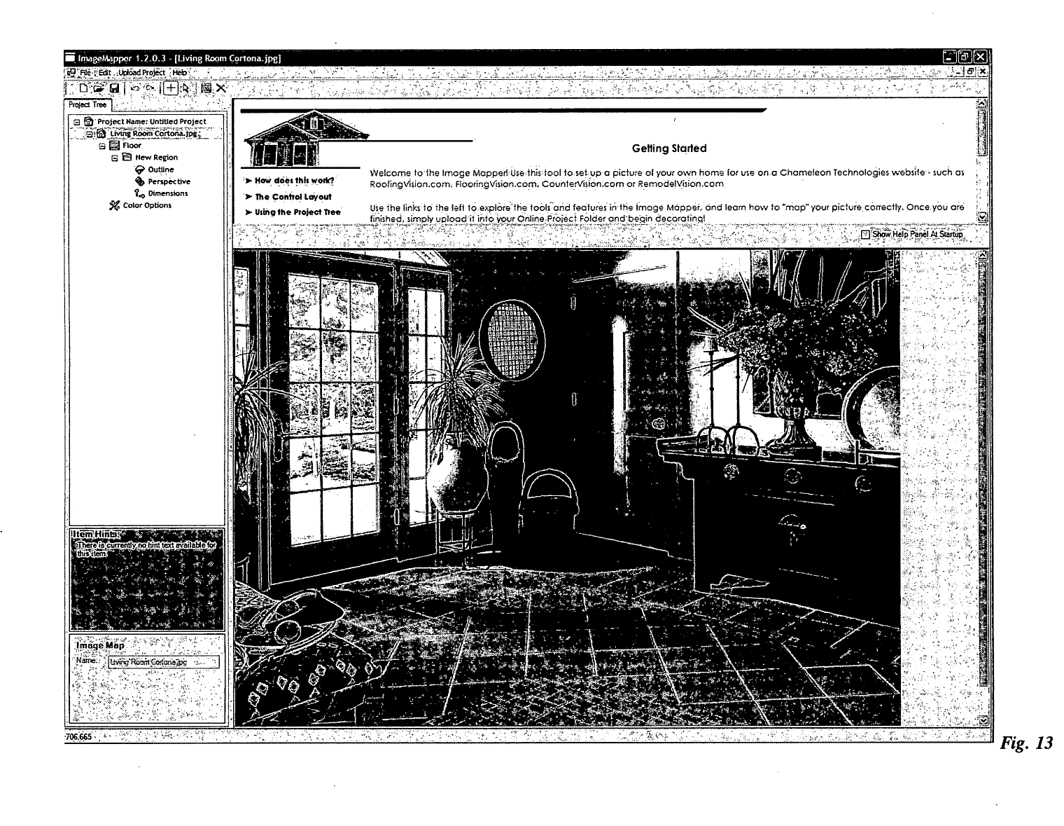

The screen shot of FIG. 13 illustrates the loaded image of a living room having the floor to be decorated.

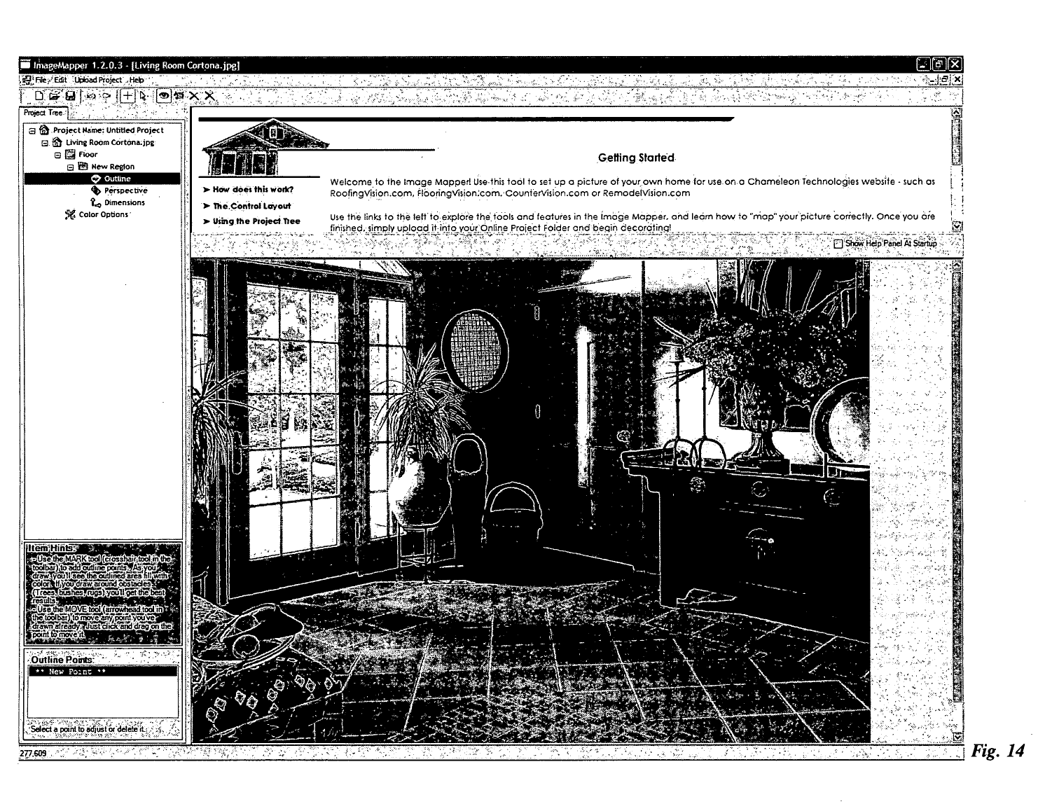

The screen shot of FIG. 14 illustrates the selection by the end user of an outline of a new region of the floor of the living room.

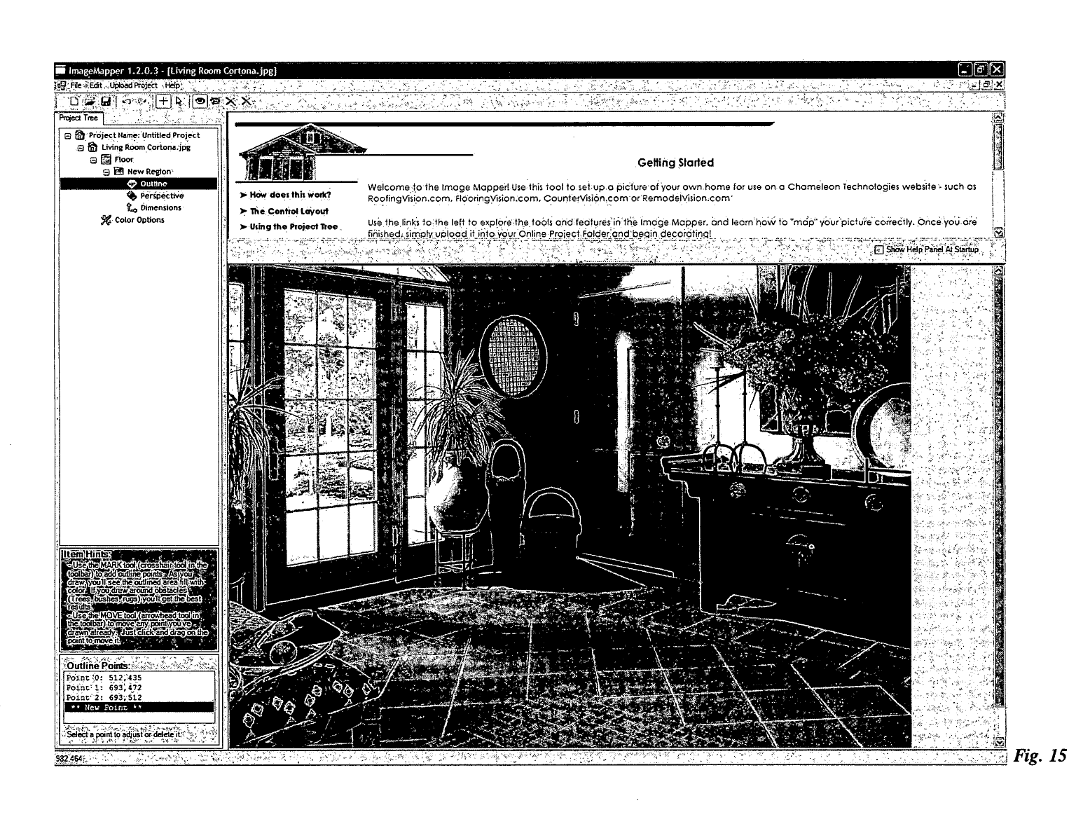

The screen shot of FIG. 15 illustrates the selection of a number of outline points wherein the user clicks points on the image to outline the surface area.

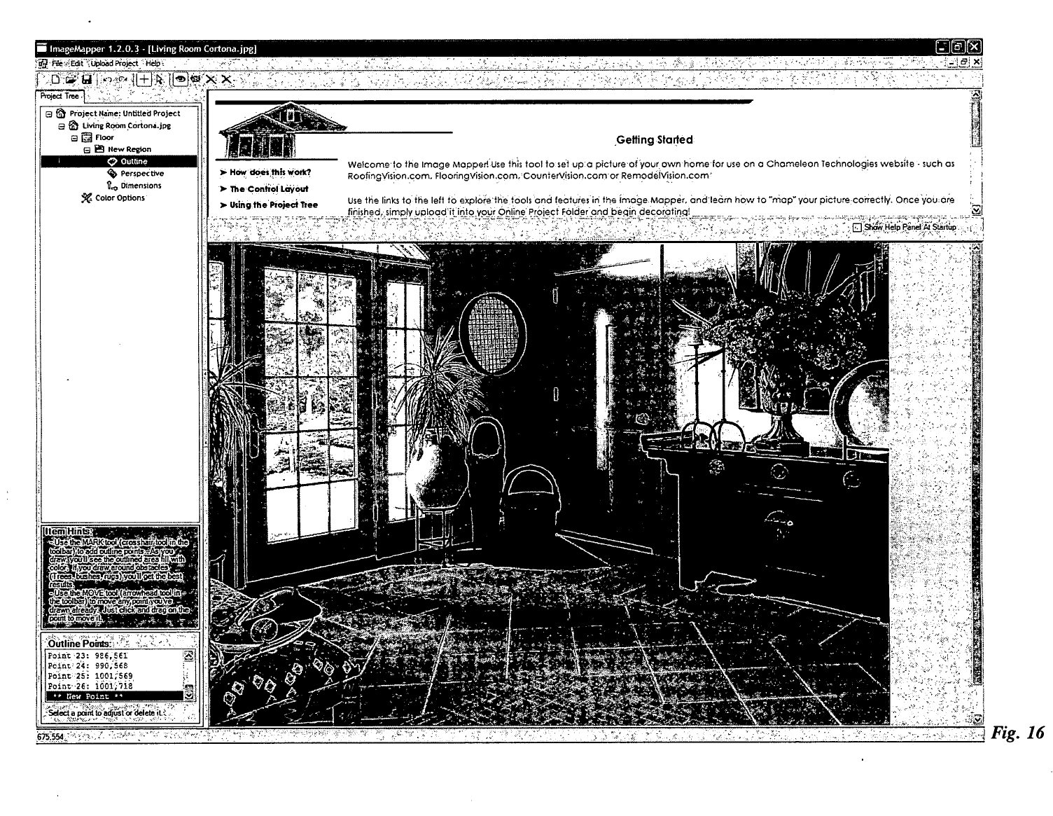

The screen shot of FIG. 16 further illustrates the selection of additional outline points where again the user clicks the new points on the image to outline the surface area.

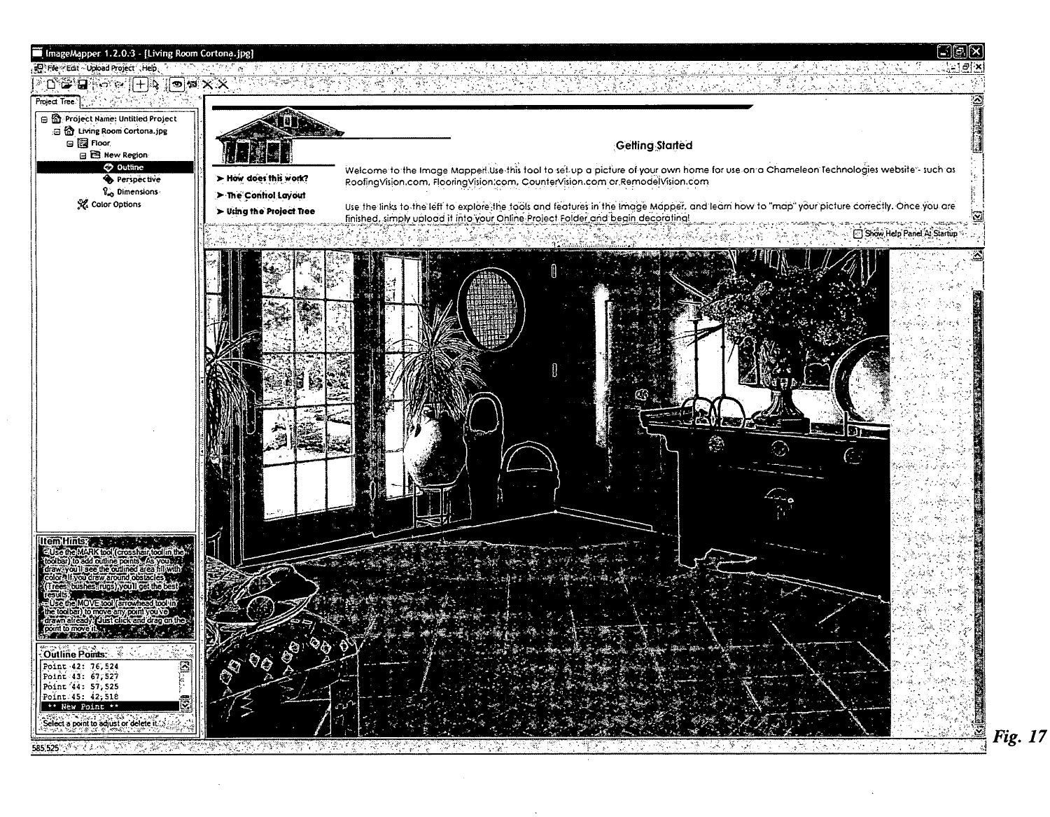

The screen shot of FIG. 17 illustrates the further selection of outline points where again the user clicks the new points on the image to outline the surface area.

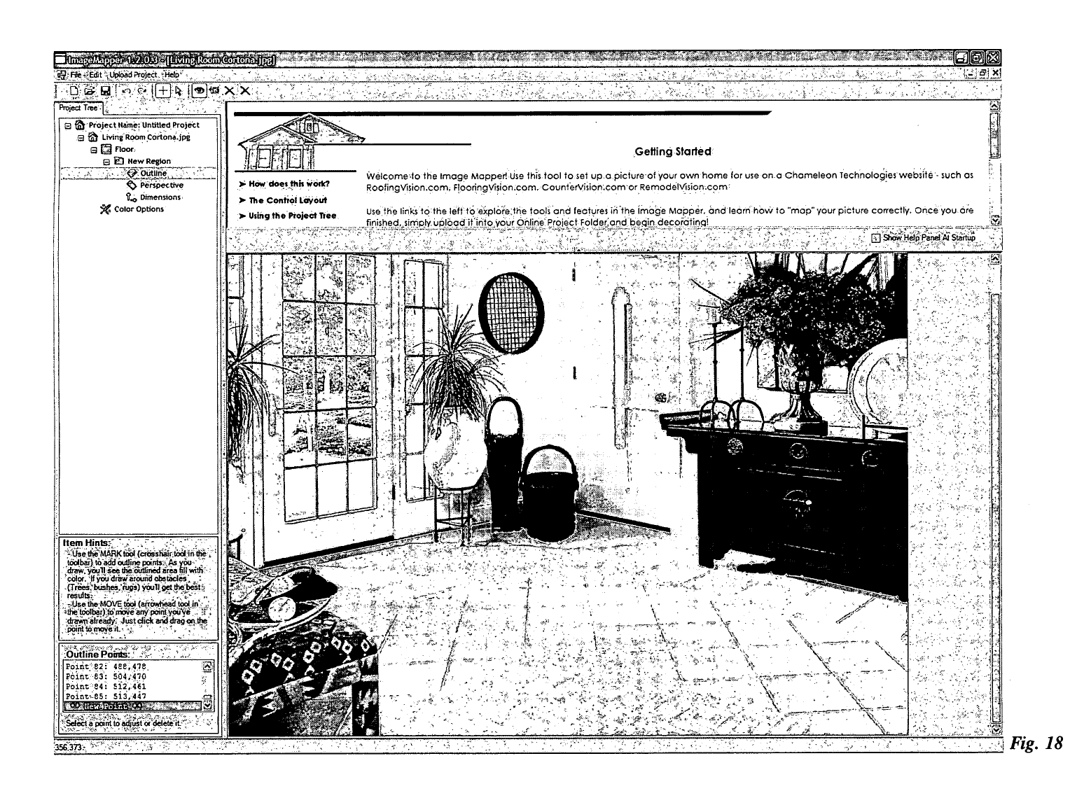

The screen shot of FIG. 18 illustrates the further selection of outline points where again the user clicks the new points on the image to outline the surface area.

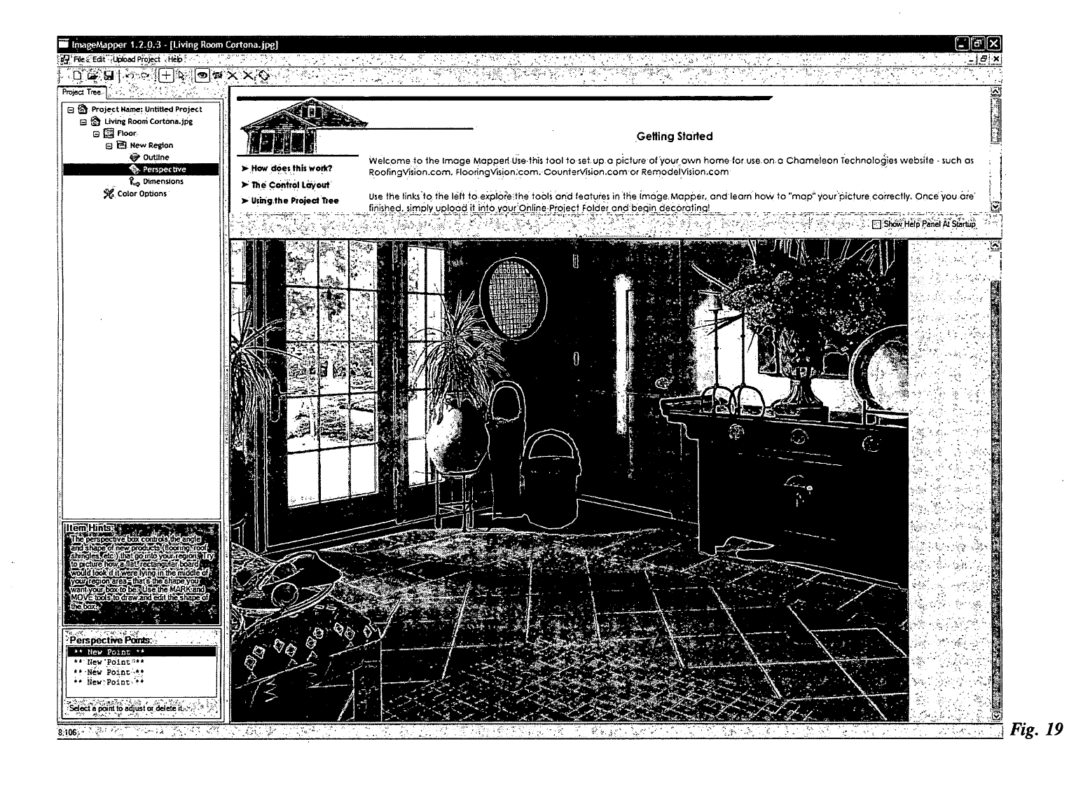

The screen shot of FIG. 19 illustrates, once the outline is complete, the user selecting a perspective of the new region wherein perspective points are to be identified.

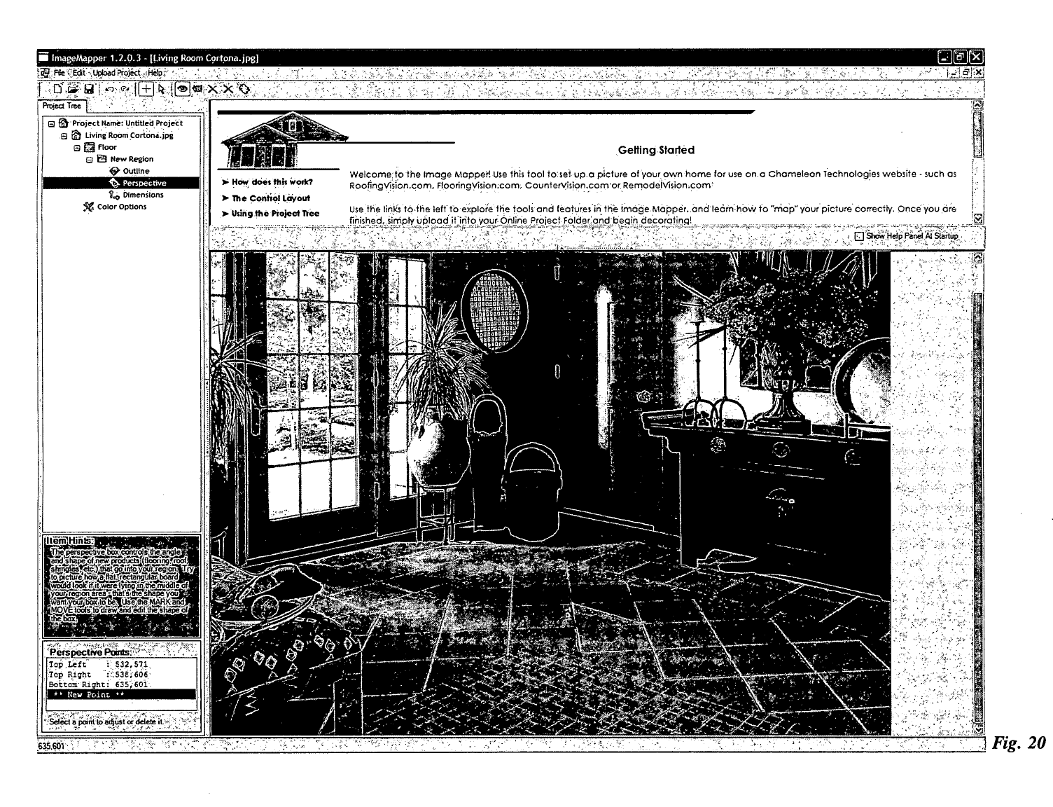

The screen shot of FIG. 20 illustrates a number of perspective points, including top left, top right and bottom right wherein the user clicks the perspective points on the image to outline a perspective area. The perspective box controls the angle and shape of new products (floorings for interior surfaces, roof shingles for exterior surfaces, etc.) to go into a particular region. The user tries to picture how a flat rectangular board would look if it were lying in the middle of the region area. That is the shape the user wants the box to be. Tools are used to draw and edit the shape of the box.

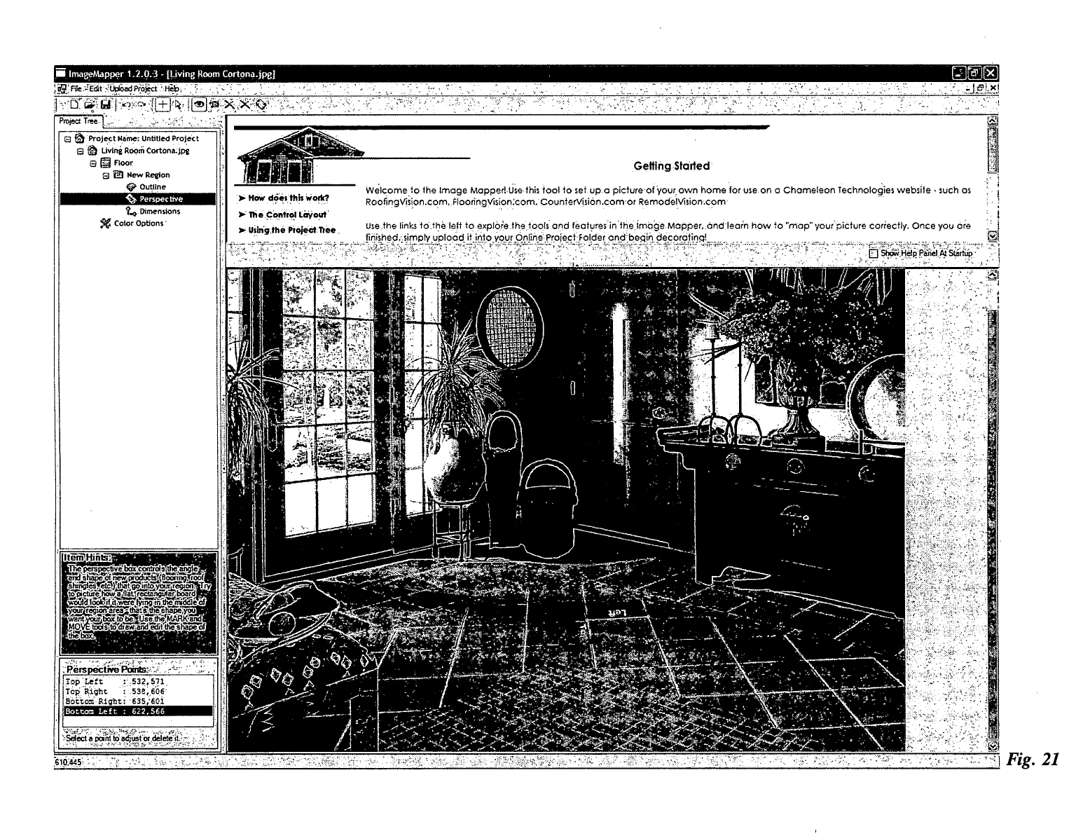

In the screen shot of FIG. 21, four perspective points have been identified by the user so that the perspective area is complete.

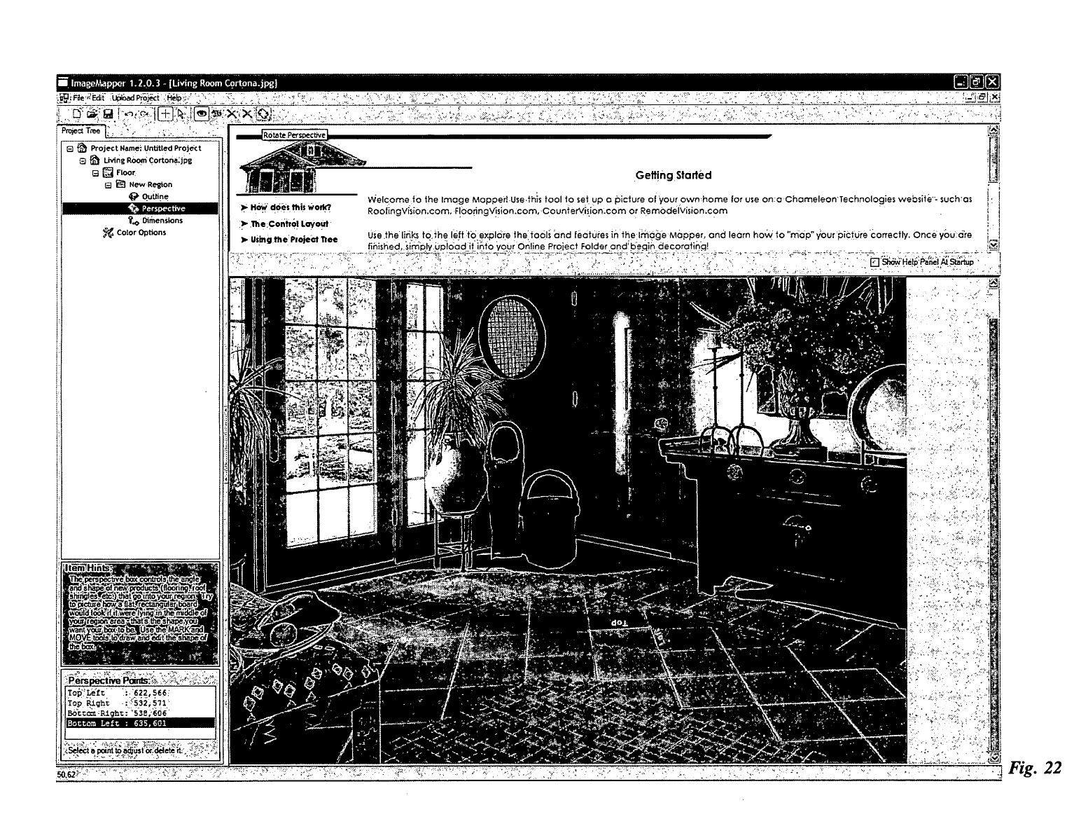

In the screen shot of FIG. 22, the user rotates the perspective area so that the top label of the perspective layer is at the top of the perspective area.

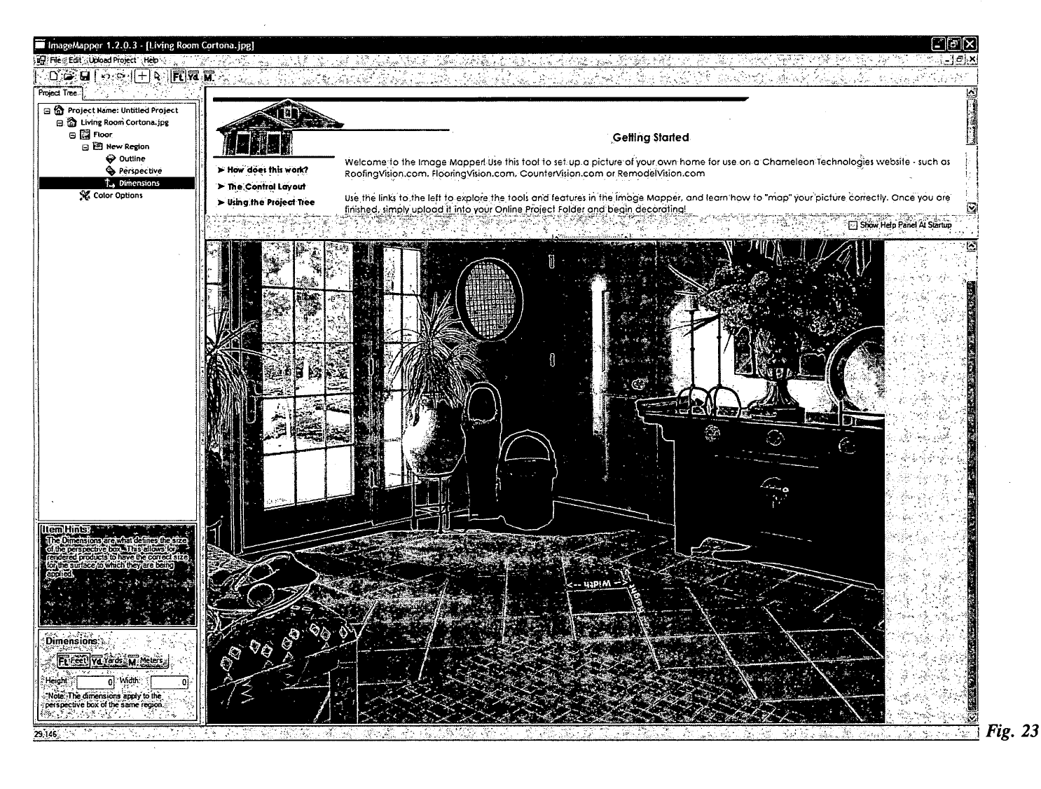

The screen shot of FIG. 23 illustrates user input of dimensions of the perspective area wherein the top of the perspective area has become the width and a side edge of the perspective area has become the height of the perspective area.

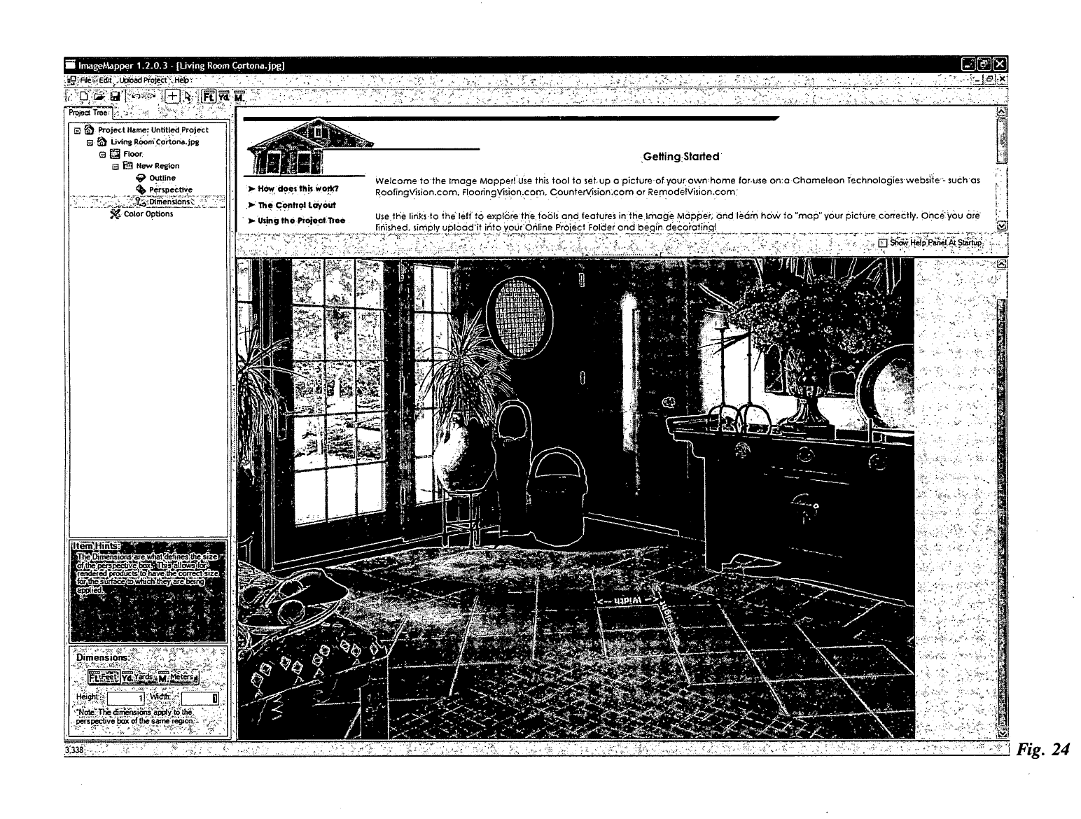

The screen shot of FIG. 24 further illustrates user input of dimensions of the perspective area.

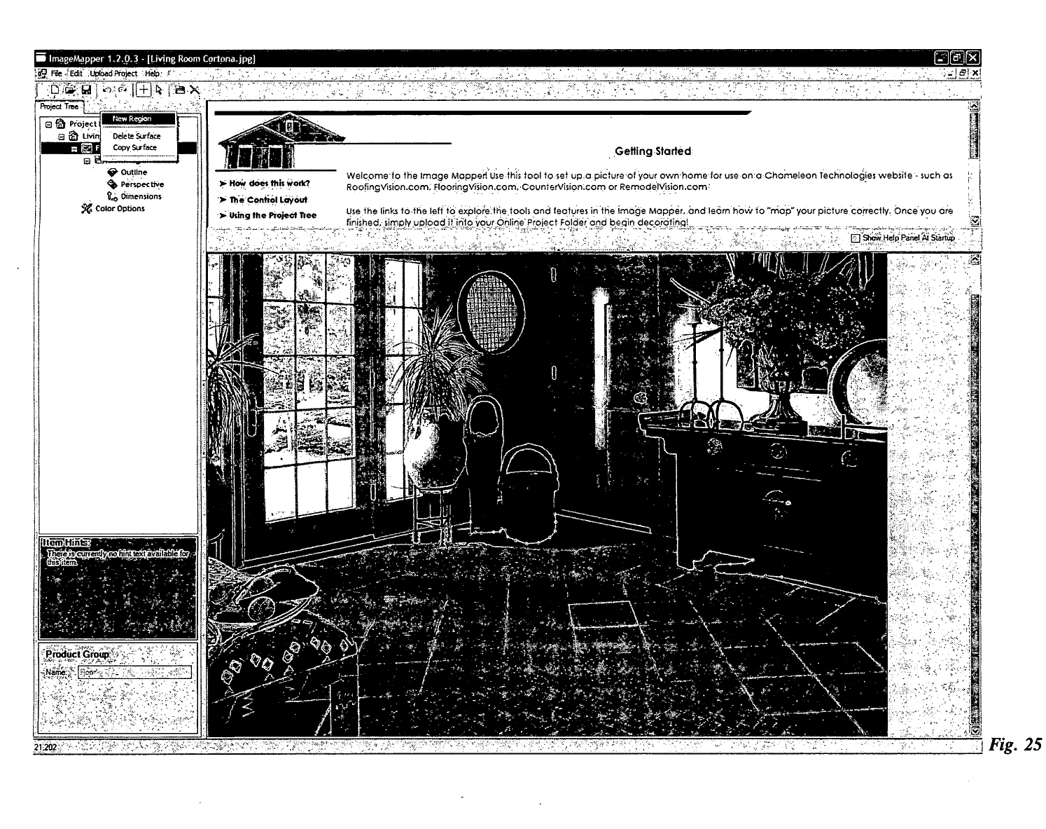

The screen shots of FIGS. 25 through 29 illustrates the mapping of a new region of the floor by repeating the same steps as previously described with respect to the first region of the floor. In particular, outline, perspective and dimension steps are performed by the user in an interactive fashion with the Image Mapper software as previously described.

In particular, the new region comprises the area in the lower lefthand corner of the floor in the image, as illustrated in the screen shots of FIGS. 25 through 28.

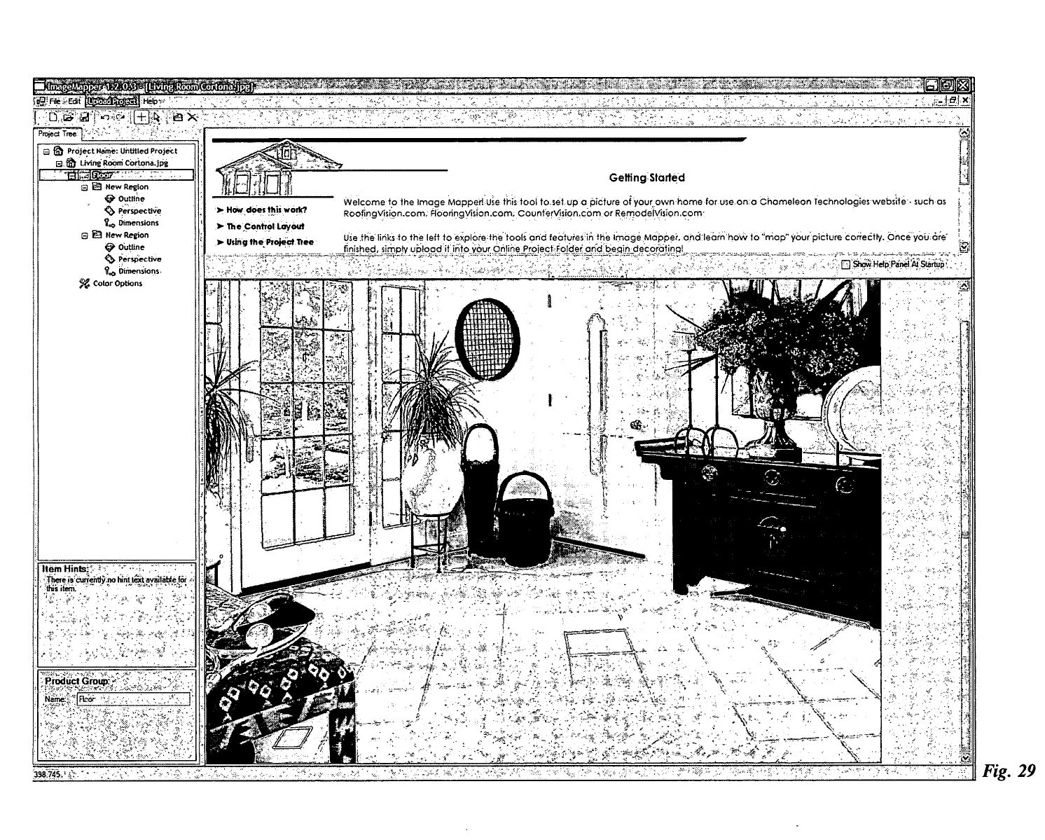

Referring now to the screen shot of FIG. 29, the user begins the upload process of the completed mapped image.

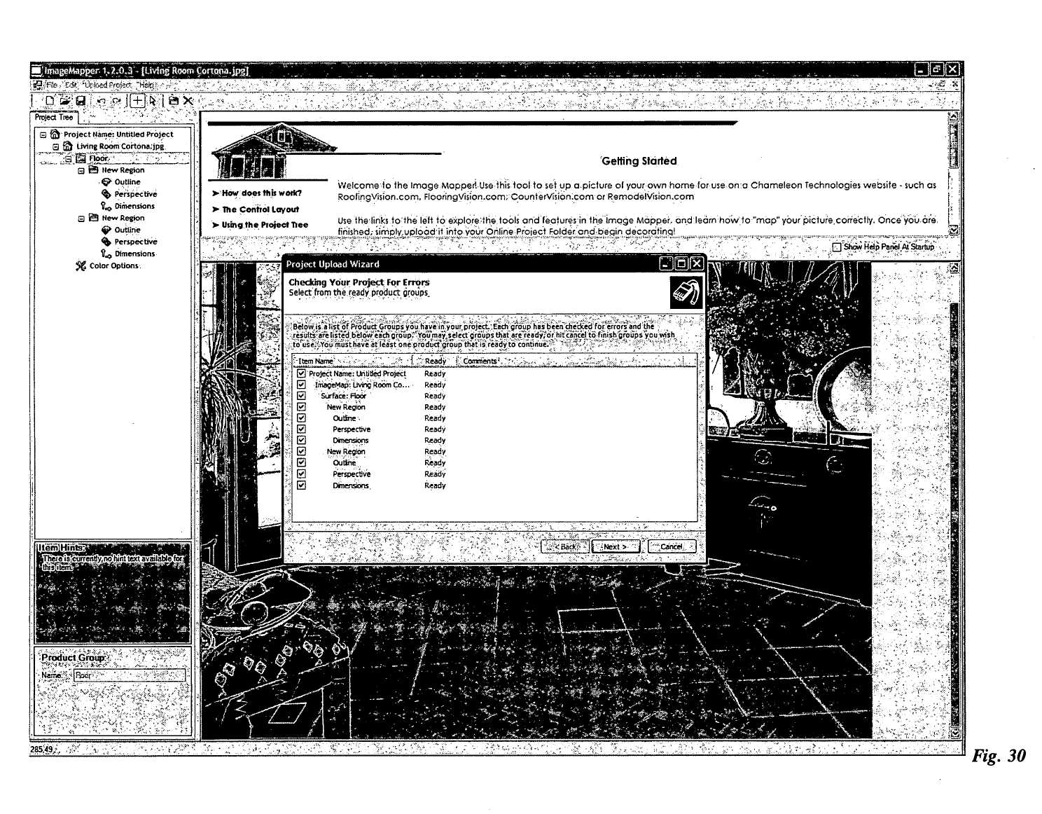

In the screen shot of FIG. 30, each region of the floor is checked for outline, perspective and dimensions wherein according to the superimposed window, all are “ready.”

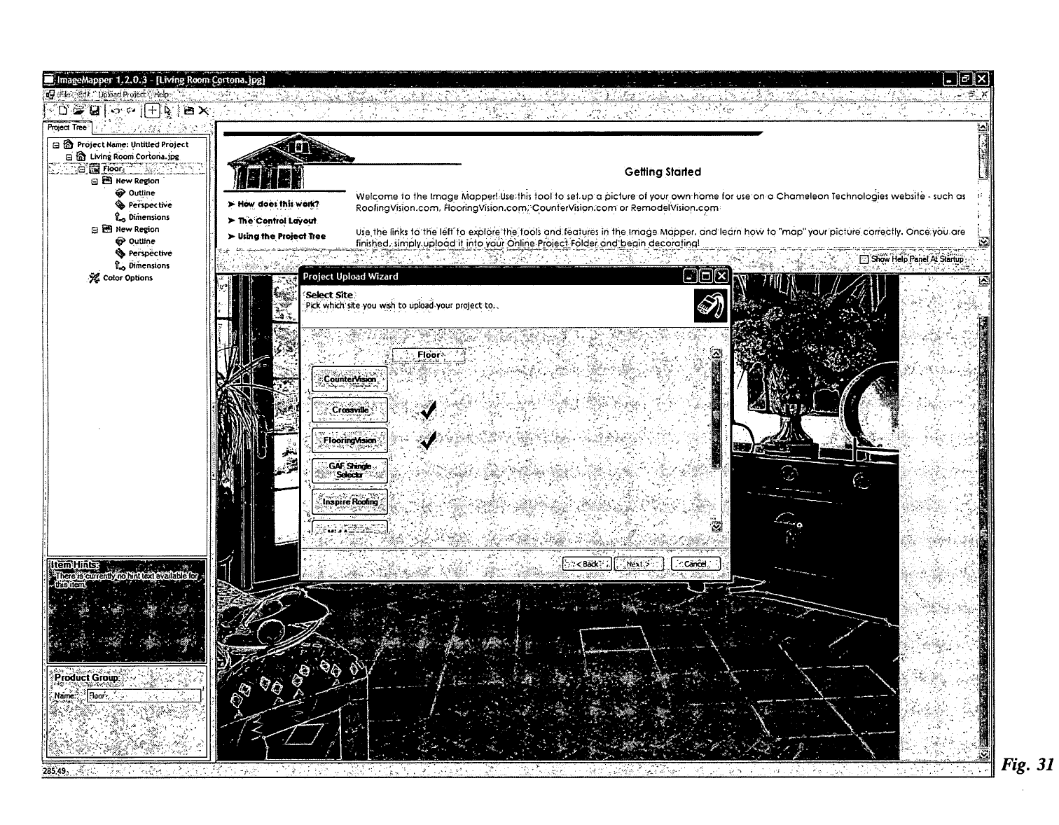

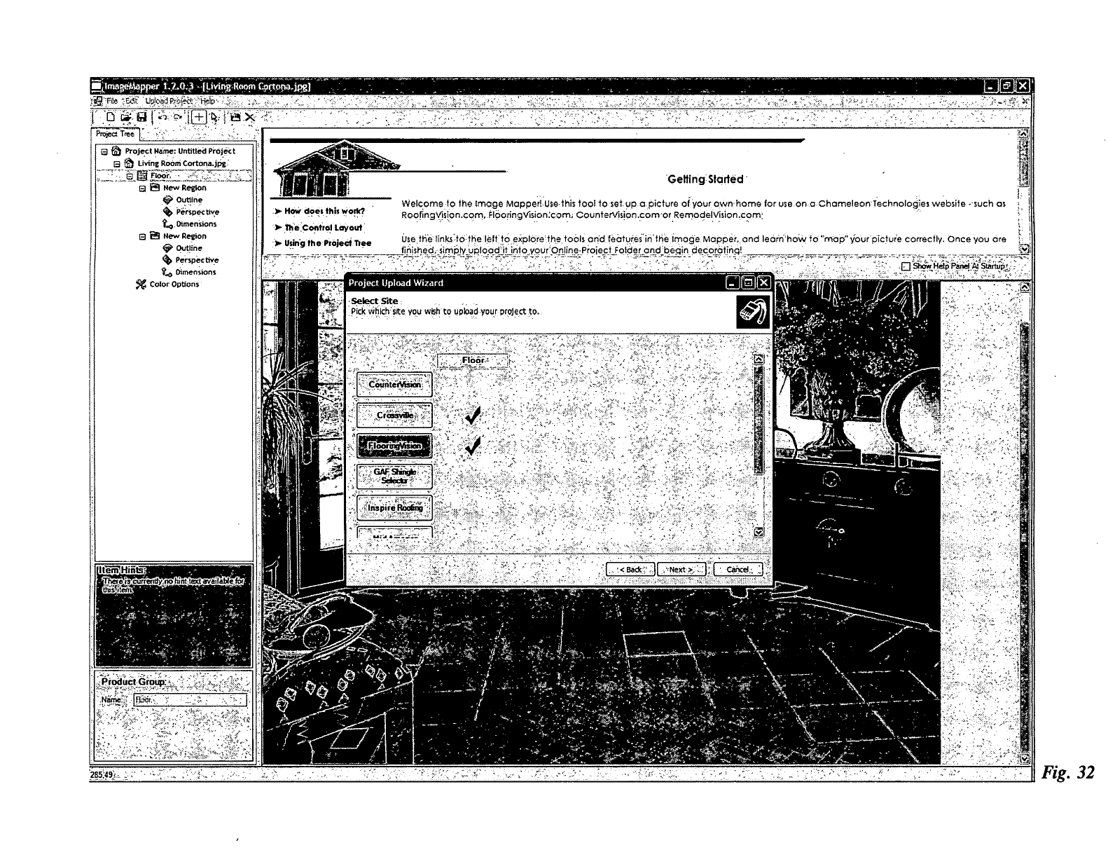

In the screen shots of FIGS. 31 and 32, the user selects the web site to upload the mapped image to. As indicated in the superimposed window, the FlooringVision and Crossville web sites are marked.

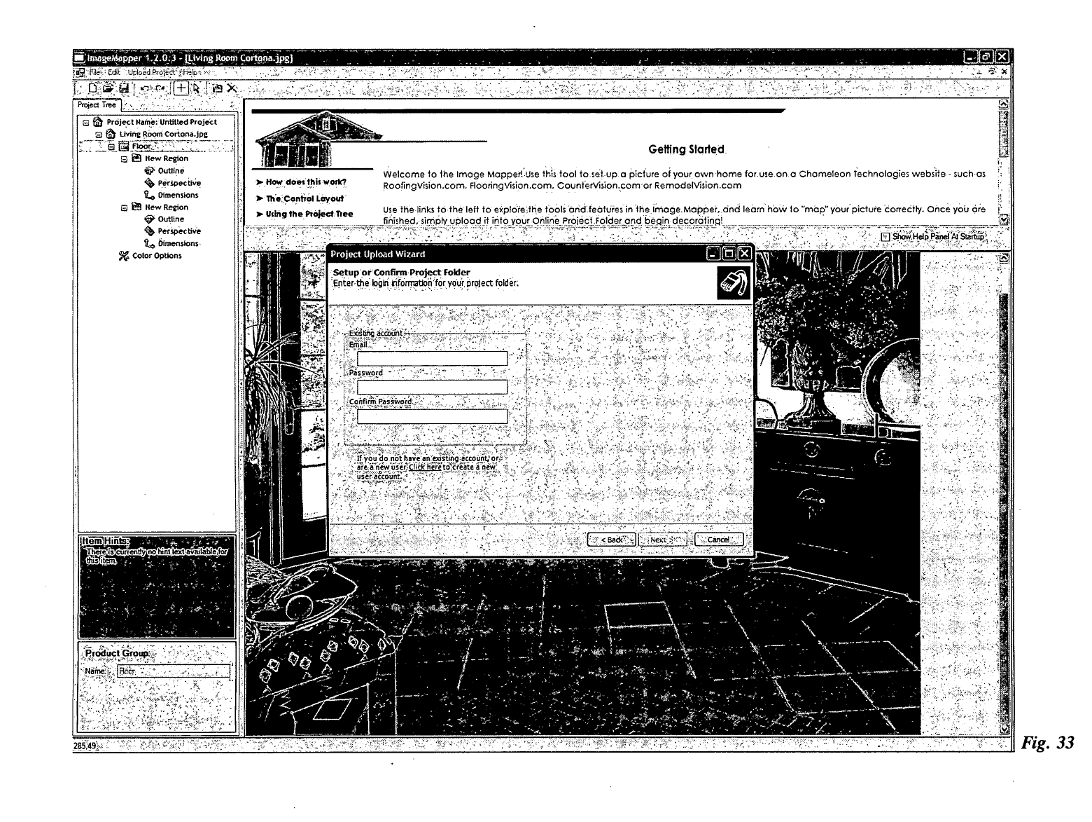

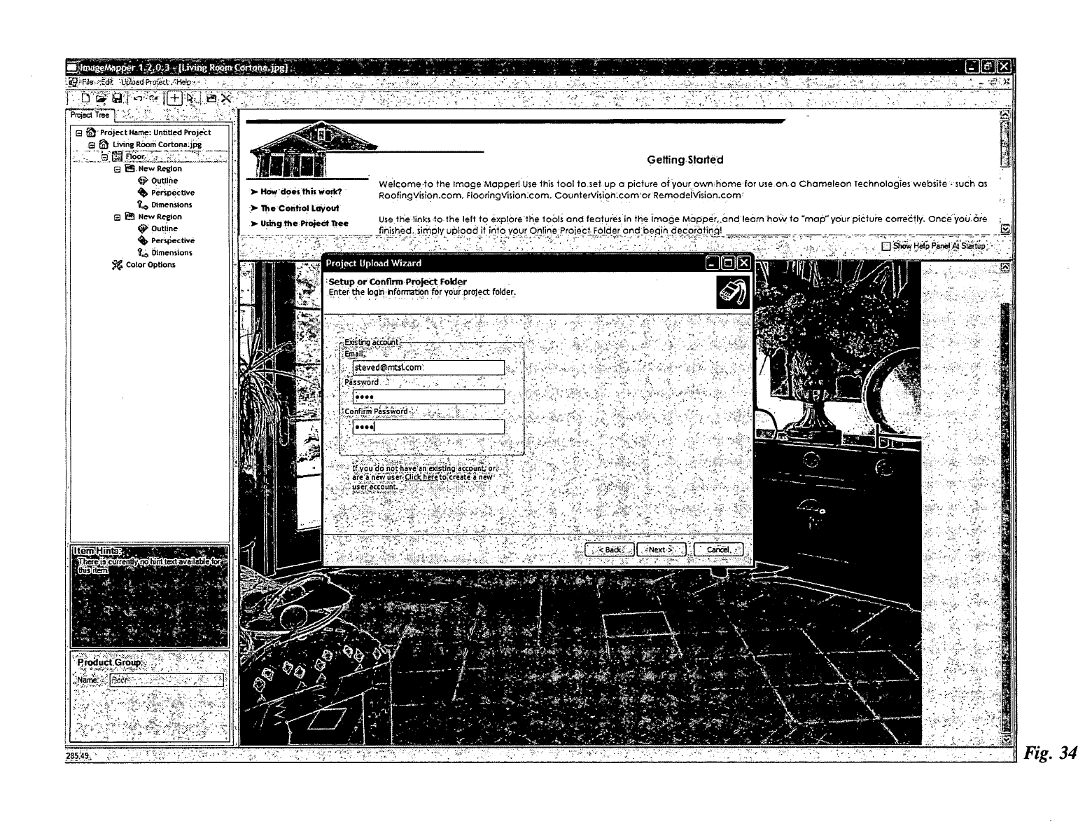

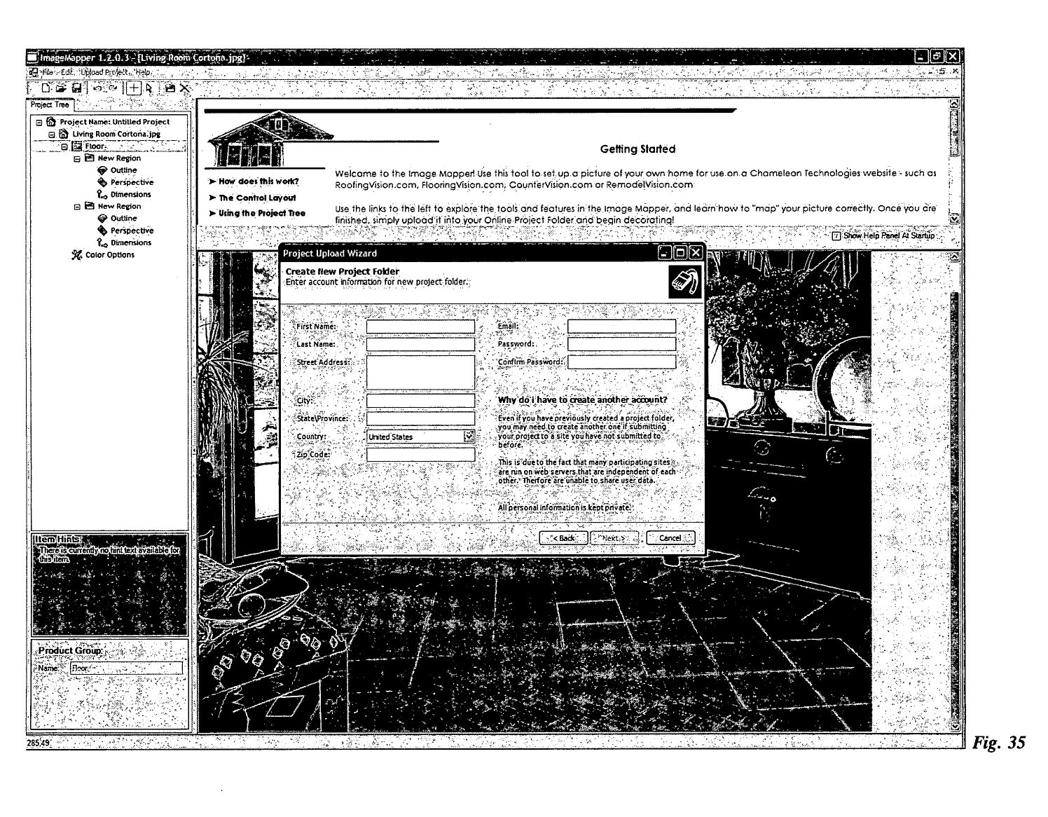

The screen shots of FIGS. 33 and 34 illustrate how a user inputs pre-existing account information for the upload process. Alternatively, as illustrated in the screen shot of FIG. 35, the user enters new information for the upload process to proceed.

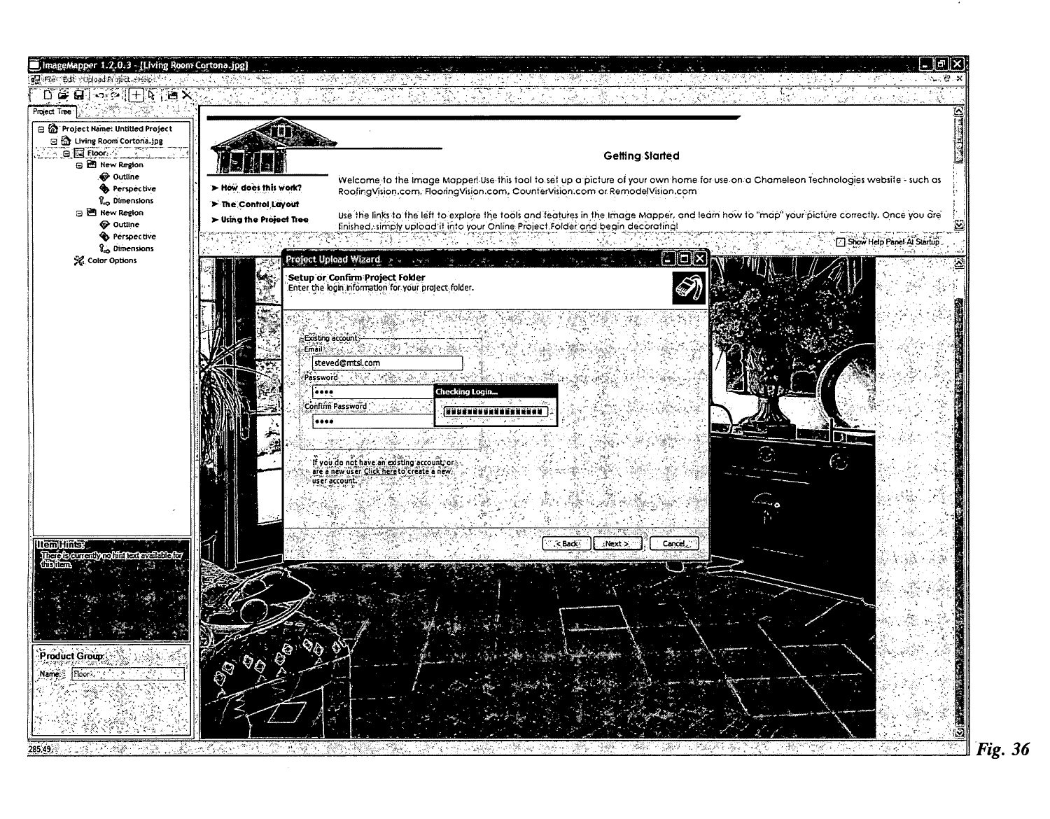

In the screen shot of FIG. 36, the user logs in.

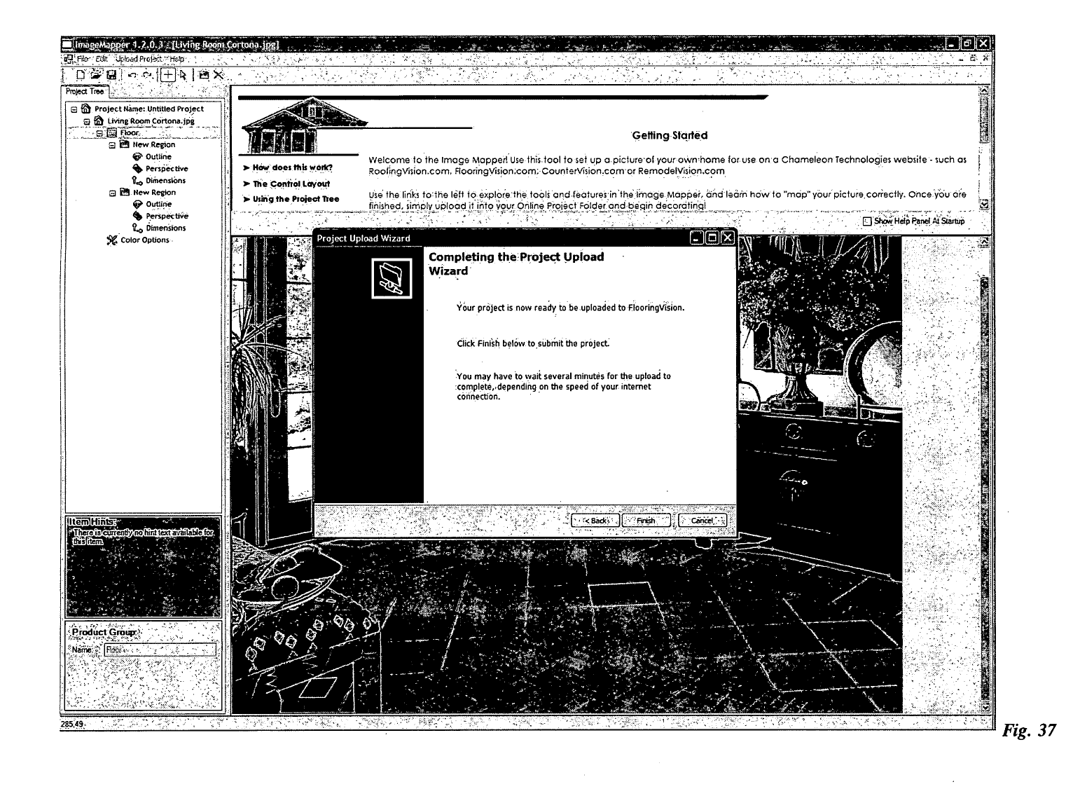

In the screen shot of FIG. 37, the user clicks finish to upload the image and the mapping data to a FlooringVision web site.

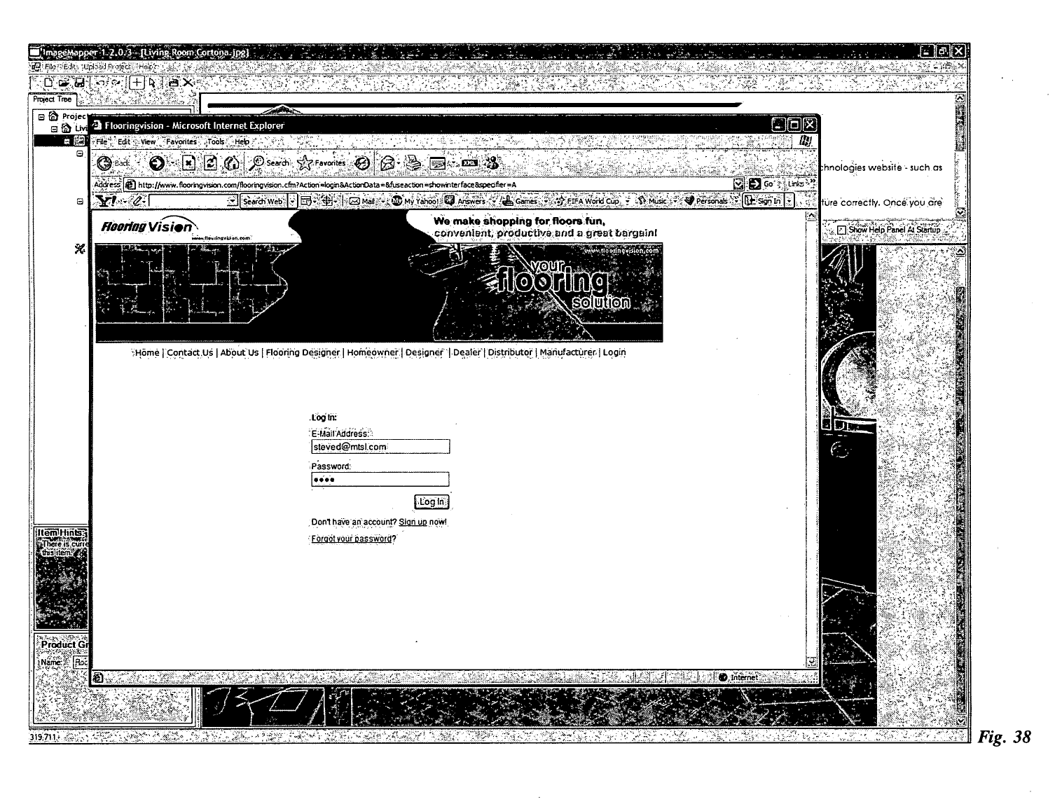

The screen shot of FIG. 38 illustrates that after the upload illustrated in the screen shot of FIG. 37, the user's local browser is opened and logged into the user's chosen web site (i.e., here the FlooringVision web site).

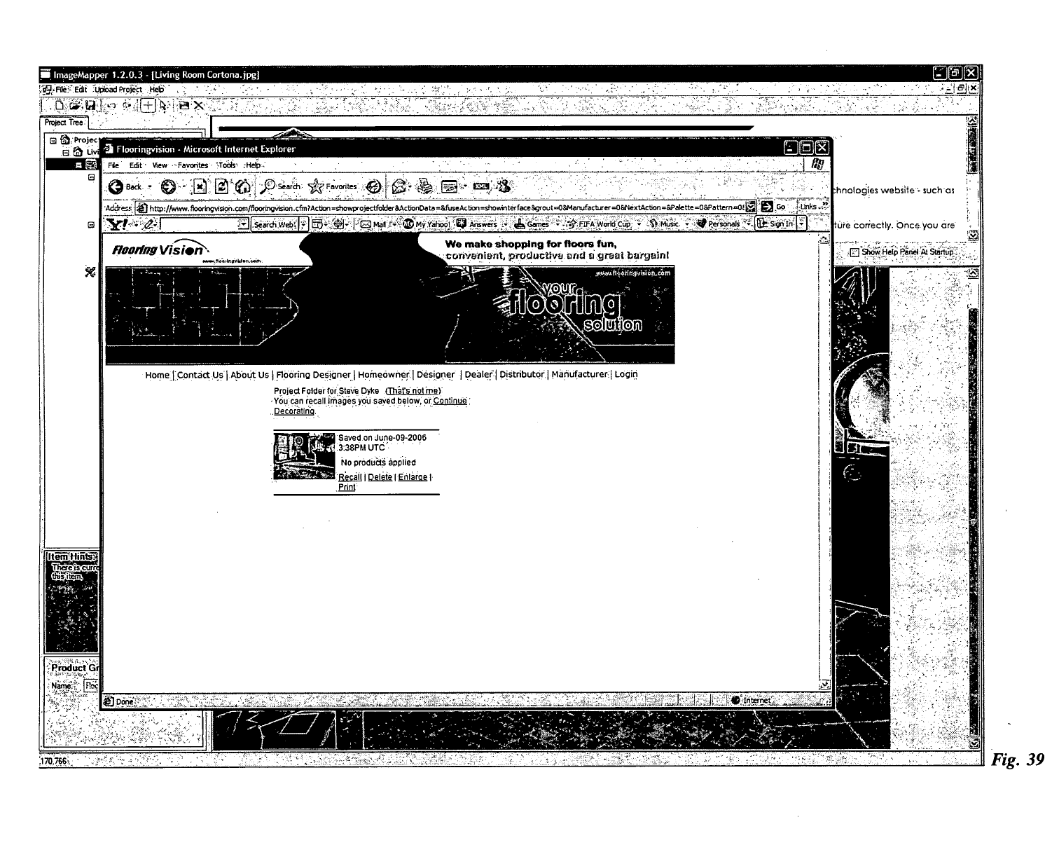

The screen shot of FIG. 39 illustrates the user selection of the uploaded image from the project folder.

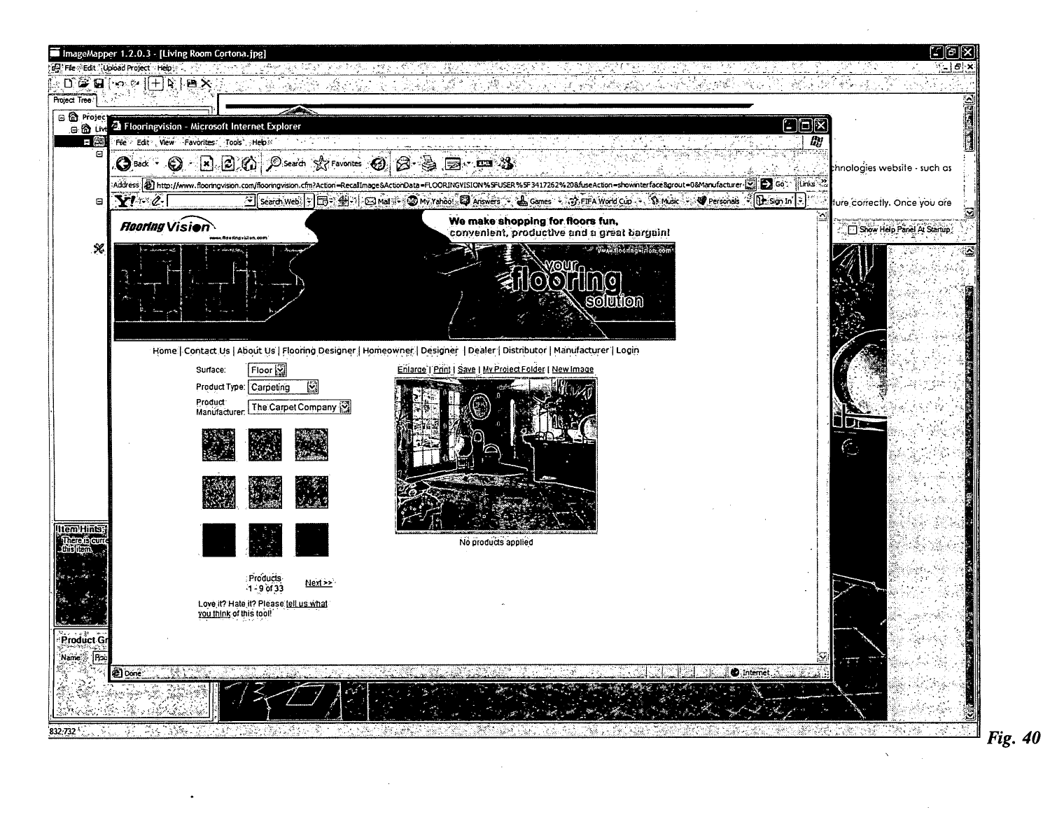

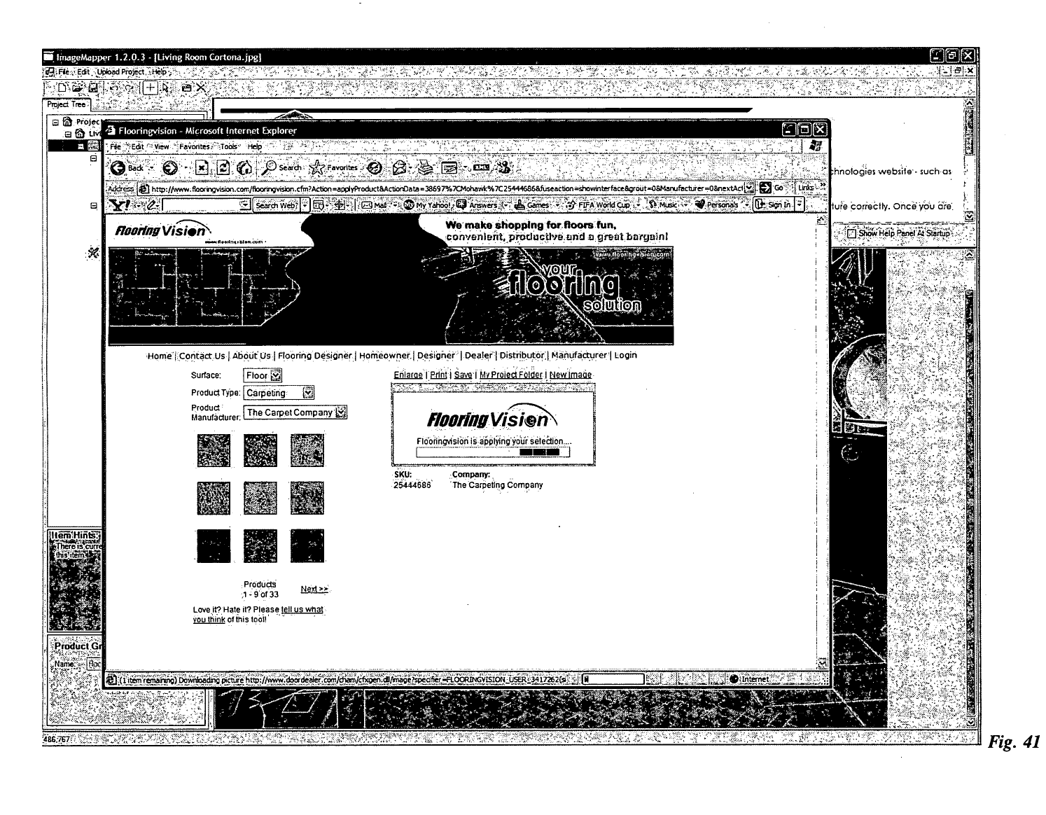

The screen shots of FIGS. 40 and 41 illustrate the user's selection of the products used to decorate the mapped surface wherein the FlooringVision web site applies the user's selection to the mapped image.

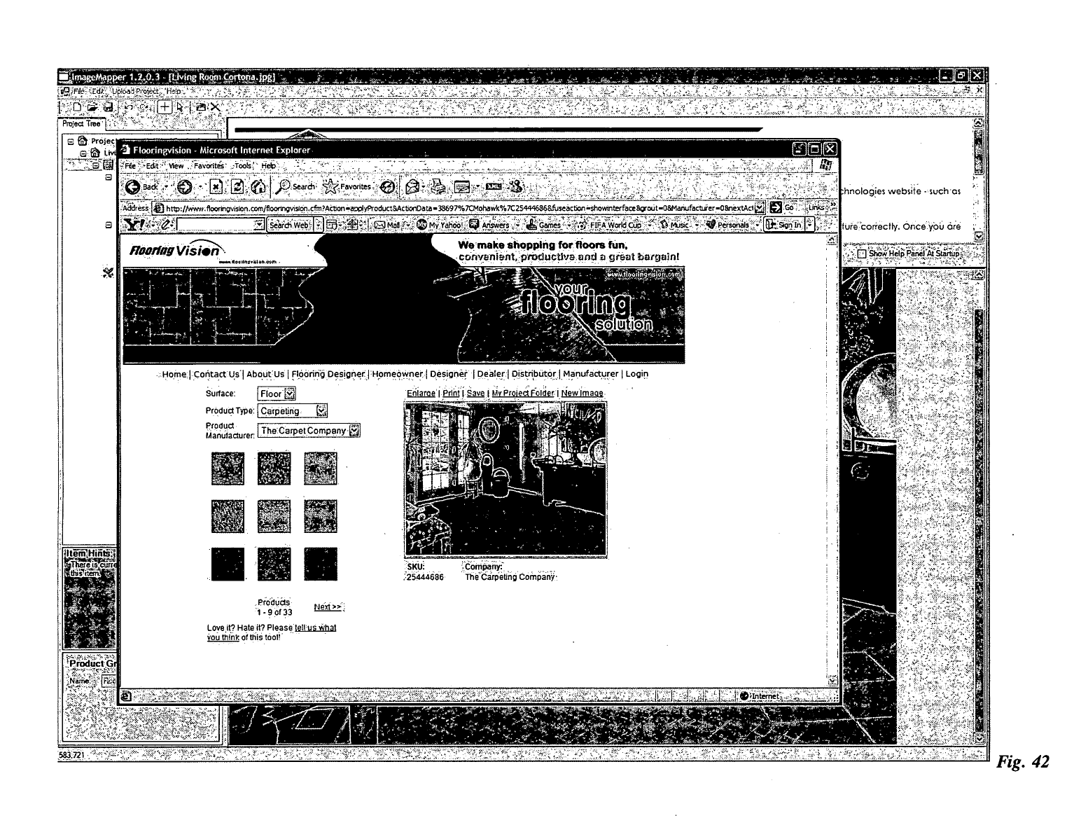

The screen shot of FIG. 42 shows a product on the user's uploaded image in the area or region that the end user mapped.

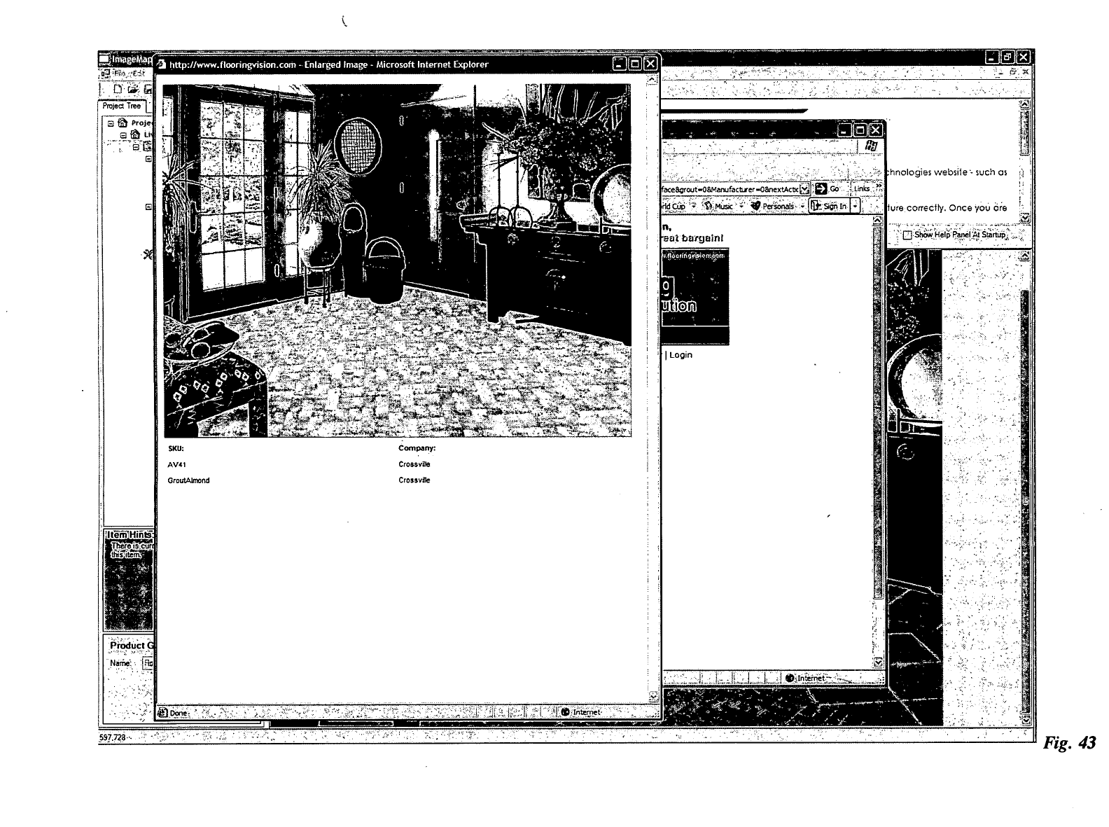

The screen shot of FIG. 43 illustrates an enlarged image of another product on the user's uploaded image in the area that has been mapped at the FlooringVision web site.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A computerized method to enable a user to remotely perform a decorating session on an electronic image, the method comprising:
receiving, at a client computer, a user-supplied digital image having an area to be decorated;
interactively mapping, at the client computer, the area to be decorated with a product to obtain a mapped image;
transmitting the mapped image to a web server over a public communications network; and
providing either the user or another user access to a user-selected web site supported by the web server over the public communications network to enable the user or other user to perform a decorating session wherein, during the session, the user or other user electronically applies product images to the area to be decorated and to view the results of the session prior to generating an order for the product.

2. The method as claimed in claim 1, wherein the step of mapping includes the step of receiving a first set of user-generated signals to select a surface of the area to be decorated with the product.

3. The method as claimed in claim 2, wherein the step of mapping includes the step of receiving a second set of user-generated signals to outline a region of the surface to be decorated.

4. The method as claimed in claim 3, wherein the step of mapping includes the step of receiving a third set of user-generated signals to outline a perspective area of the region, the perspective area controlling angle and shape of the product to be applied to the region.

5. The method as claimed in claim 4, wherein the step of mapping includes the step of receiving a fourth set of user-generated signals to rotate the perspective area.

6. The method as claimed in claim 4, wherein the step of mapping includes the step of receiving a fifth set of user-generated signals to obtain dimensions of the perspective area.

7. The method as claimed in claim 1, wherein the user-supplied digital image is a photographic image.

8. The method as claimed in claim 1, wherein the area is an exterior surface of a building and the product is an exterior product.

9. The method as claimed in claim 1, wherein the area is an interior surface of a building and the product is an interior product.

10. A system to enable a user to remotely perform a decorating session on an electronic image, the system comprising:
means for receiving a user-supplied digital image having an area to be decorated; and
a client computer configured to:
interactively map the area to be decorated with a product to obtain a mapped image;
transmit the mapped image to a web server over a public communications network; and
provide either the user or another user access to a user-selected web site supported by the web server over the public communications network to enable the user or other user to perform a decorating session wherein, during the session, the user or other user electronically applies product images to the area to be decorated and to view the results of the session prior to generating an order for the product.

11. The system as claimed in claim 10, wherein the client computer is configured to receive a first set of user-generated signals to select a surface of the area to be decorated with the product.

12. The system as claimed in claim 11, wherein the client computer is configured to receive a second set of user-generated signals to outline a region of the surface to be decorated.

13. The system as claimed in claim 12, wherein the client computer is configured to receive a third set of user-generated signals to outline a perspective area of the region, the perspective area controlling angle and shape of the product to be applied to the region.

14. The system as claimed in claim 13, wherein the client computer is configured to receive a fourth set of user-generated signals to rotate the perspective area.

15. The system as claimed in claim 13, wherein the client computer is configured to receive a fifth set of user-generated signals to obtain dimensions of the perspective area.

16. The system as claimed in claim 10, wherein the user-supplied digital image is a photographic image.

17. The system as claimed in claim 10, wherein the area is an exterior surface of a building and the product is an exterior product.

18. The system as claimed in claim 10, wherein the area is an interior surface of a building and the product is an interior product.

19. A machine-readable medium having encoded thereon program code, wherein, when the program code is execute on a machine, the machine implements a method to enable a user to remotely perform a decorating session on an electronic image, the method comprising the steps of:
receiving a user-supplied digital image having an area to be decorated;
interactively mapping the area to be decorated with a product to obtain a mapped image;
transmitting the mapped image to a web server over a public communications network; and
providing either the user or another user access to a user-selected web site supported by the web server over the public communications network to enable the user or other user to perform a decorating session wherein, during the session, the user or other user electronically applies product images to the area to be decorated and to view the results of the session prior to generating an order for the product.

20. The medium as claimed in claim 19, wherein the step of mapping includes the step of receiving a first set of user-generated signals to select a surface of the area to be decorated with the product.

21. The medium as claimed in claim 20, wherein the step of mapping includes the step of receiving a second set of user-generated signals to outline a region of the surface to be decorated.

22. The medium as claimed in claim 21, wherein the step of mapping includes the step of receiving a third set of user-generated signals to outline a perspective area of the region, the perspective area controlling angle and shape of the product to be applied to the region.

23. The medium as claimed in claim 22, wherein the step of mapping includes the step of receiving a fourth set of user-generated signals to rotate the perspective area.

24. The medium as claimed in claim 22, wherein the step of mapping includes the step of receiving a fifth set of user-generated signals to obtain dimensions of the perspective area.

25. The medium as claimed in claim 19, wherein the user-supplied digital image is a photographic image.

26. The medium as claimed in claim 19, wherein the area is an exterior surface of a building and the product is an exterior product.

27. The medium as claimed in claim 19, wherein the area is an interior surface of a building and the product is an interior product.
